(19) United States
(12) Patent Application Publication
(10) Pub. No.: US 2024/0004709 A1
(43) Pub. Date: Jan. 4, 2024

(54) Concept for Software Application Container Hardware Resource Allocation

(71) Applicant: Intel Corporation, Santa Clara, CA (US)

(72) Inventors: Rajesh POORNACHANDRAN, PORTLAND, OR (US); Kshitij A. DOSHI, Tempe, AZ (US); Rita H. WOUHAYBI, Portland, OR (US); Francesc GUIM BERNAT, Barcelona (ES); Marcos CARRANZA, Portland, OR (US)

(21) Appl. No.: 17/809,968

(22) Filed: Jun. 30, 2022

(51) Int. Cl. G06F 9/50

(52) U.S. Cl. CPC G06F 9/5005

(57) ABSTRACT

Examples relate to a concept for software application container hardware resource allocation, and in particular to sidecar apparatuses, sidecar devices, methods for a software application container sidecars, a resource management controller apparatus, a resource management controller device, and corresponding computer programs and computer systems. A sidecar apparatus comprises interface circuitry, machine-readable instructions and processing circuitry to execute the machine-readable instructions to obtain information on hardware resources desired by a software application container from the software application container, and to provide a request for changing the hardware resources allocated to the software application container to another entity capable of influencing an allocation of hardware resources to the software application container.

### FIELD

Examples relate to a concept for software application container hardware resource allocation, and in particular to sidecar apparatuses, sidecar devices, methods for a software application container sidecars, a resource management controller apparatus, a resource management controller device, and corresponding computer programs and computer systems.

### BACKGROUND

The use of software application containers, e.g., for the implementation of so-called microservices, is a popular choice amongst developers of complex interconnected system. Such software application containers are assigned hardware resources, which can then be utilized by the respective application containers during hosting of the software application containers. While such hardware resources may include central processing unit (CPU) resources, memory resources or storage resources being provided by a computer system hosting the software application container, such hardware resources may also include outer resources, e.g., GPU (Graphics Processing Unit) resources, FPGA (Field-Programmable Gate Array) resources or artificial intelligence accelerator resources, which may be provided by hardware included in another computer system. In general, the hardware resources being available to a software application container hosting a microservice are specified declaratively at container and/or pod creation time. Scalable microservices architecture allows microservices to be split up and deployed dynamically and at scale, potentially across multiple data centers and cloud platforms. Given this, it may become harder to hardwire connections between the various services during creation time. For example, static, non-scalable hard partitioning and allocation of resources may not provide the elasticity desired for microservices to grow or shrink transparently.

### BRIEF DESCRIPTION OF THE FIGURES

Some examples of apparatuses and/or methods will be described in the following by way of example only, and with reference to the accompanying figures, in which

FIG. 1a shows a schematic diagram of an example of a sidecar apparatus or sidecar device, and of a computer system comprising such a sidecar apparatus or sidecar device;

FIG. 1b shows a flow chart of an example of a method for a software application container sidecar;

FIG. 1c shows a schematic diagram of an example of an interaction between a sidecar apparatus or sidecar device and a resource management controller;

FIG. 1d shows a schematic diagram of an example of an interaction between a sidecar apparatus or sidecar device and a second sidecar apparatus or sidecar device;

FIG. 1e shows a flow chart of an example of a second method for a second software application container sidecar;

FIG. 2a shows a schematic diagram of an example of a resource management controller apparatus or resource management controller device, and of a computer system comprising such a resource management controller apparatus or resource management controller device;

FIG. 2b shows a flow chart of an example of a resource management controller method;

FIG. 3 shows a schematic diagram of an example of a system architecture; and

FIG. 4 shows a flow chart of an example of an operational flow.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e., only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

In the following description, specific details are set forth, but examples of the technologies described herein may be practiced without these specific details. Well-known circuits, structures, and techniques have not been shown in detail to avoid obscuring an understanding of this description. “An example/example,” “various examples/examples,” “some examples/examples,” and the like may include features, structures, or characteristics, but not every example necessarily includes the particular features, structures, or characteristics.

Some examples may have some, all, or none of the features described for other examples. “First,” “second,” “third,” and the like describe a common element and indicate different instances of like elements being referred to. Such adjectives do not imply element item so described must be in a given sequence, either temporally or spatially, in ranking, or any other manner. “Connected” may indicate elements are in direct physical or electrical contact with each other and “coupled” may indicate elements co-operate or interact with each other, but they may or may not be in direct physical or electrical contact.

As used herein, the terms “operating”, “executing”, or “running” as they pertain to software or firmware in relation to a system, device, platform, or resource are used interchangeably and can refer to software or firmware stored in one or more computer-readable storage media accessible by the system, device, platform or resource, even though the instructions contained in the software or firmware are not actively being executed by the system, device, platform, or resource.

The description may use the phrases “in an example/example,” “in examples/examples,” “in some examples/examples,” and/or “in various examples/examples,” each of which may refer to one or more of the same or different examples. Furthermore, the terms “comprising,” “including,” “having,” and the like, as used with respect to examples of the present disclosure, are synonymous.

Various examples of the present disclosure relate to a concept for Seamless Dynamic Resource Management (SDRM), e.g., for microservices or other software applications that are hosted using software containers.

Examples may provide a transparent, scalable hardware resource management that can support the low-latency and scalable elasticity expected by scalable microservices. The aforementioned Seamless Dynamic Resource Management (SDRM) may allow the underlying hardware resources to scale, and thus implement grow-or-shrink-as-you-go model. Various resourcing services in the infrastructure (pooled memory, distributed storage, computational resources available for in-network-compute, etc.) may be made available by registration through infrastructure services. Application sidecars can then forward requests from microservices to these resource provider and pooling services. The client microservices may obtain various dynamically pooled resources and automatically expand or shrink and release non-needed capacities through the sidecars. The sidecars may provide an API to the client application's software to provide a try-and-grow, grow-after-time-X, shrink, shrink-after-time-X, replace, replace-after-time X APIs so that the sidecars can obtain, schedule, and return the pooled resources. All of this may happen without the application software having to be platform software conscious or having to know what is available where. The proposed concept may be suitable for ad-hoc use of expensive resources like AI (Artificial Intelligence) accelerators, FPGA slices, ephemeral storage, memory for mature cold objects, memory for denormalized database tables, higher latency but higher capacity network slices, etc.

The proposed SDRM may enable a dynamic addition and removal of hardware resources at pods/containers/virtual machines/etc., to enable scale (grow-or-shrink-as-you-go) model. It may provide discovery, e.g., various resourcing services in the infrastructure (pooled memory, distributed storage, computational resources available for in-network-compute, etc.) may be made available by registration through infrastructure services. It may use a sidecar resource scaler. Application sidecars may forward requests from microservices to this resource provider and pooling services. The client microservices may obtain various dynamically pooled resources and automatically expand or shrink and release non-needed capacities through the sidecars.

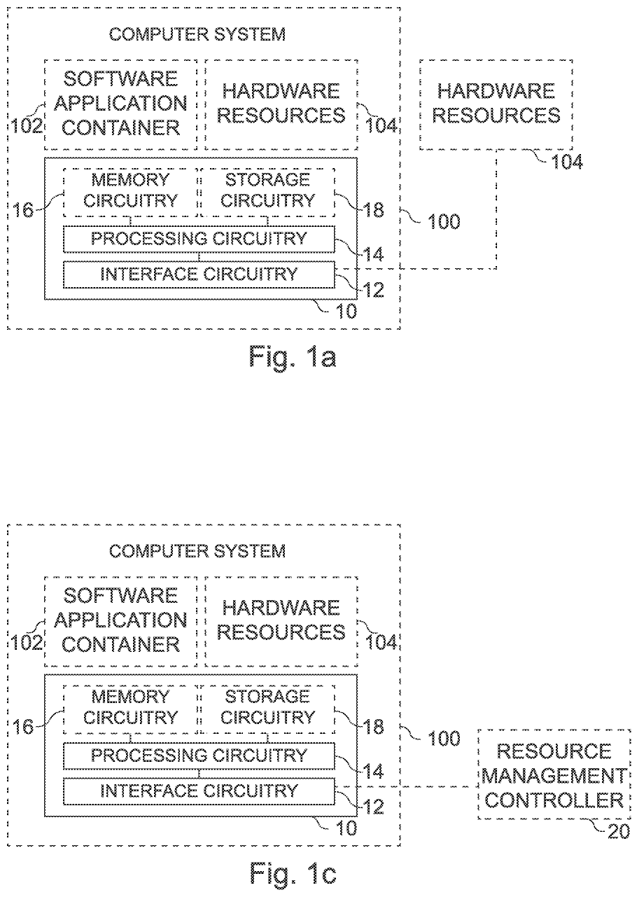

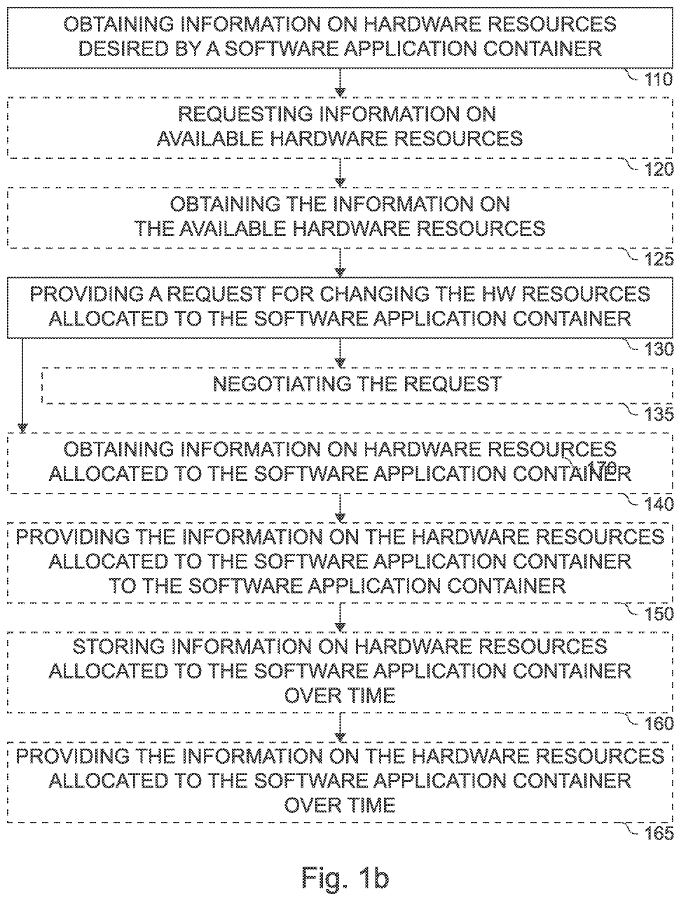

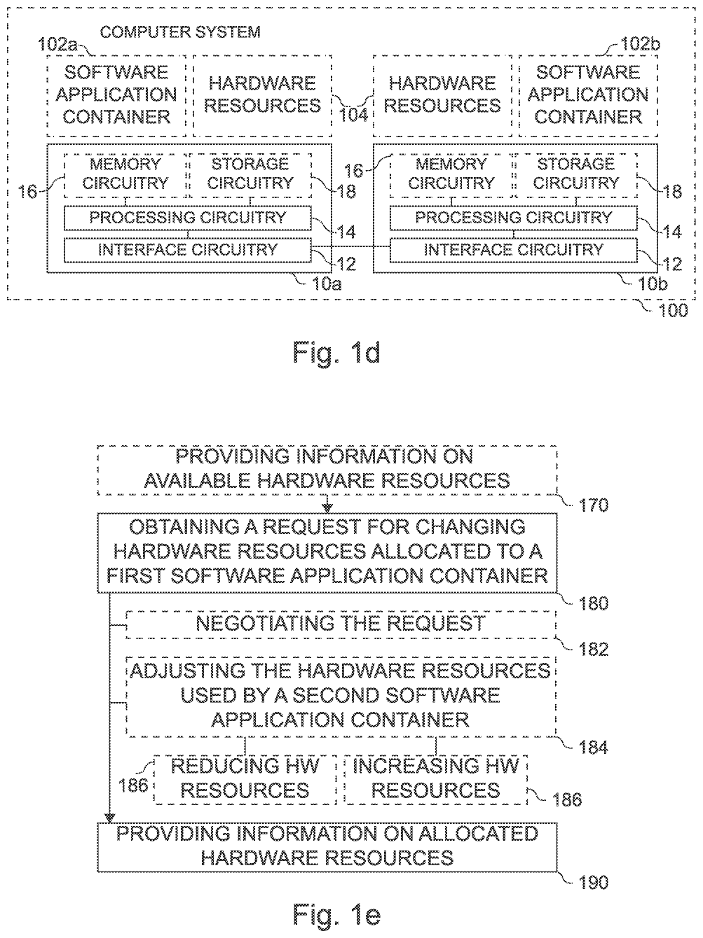

FIG. 1a shows a schematic diagram of an example of a sidecar apparatus 10 or sidecar device and of a computer system 100 comprising such a sidecar apparatus 10 or sidecar device 10. The sidecar apparatus 10 comprises circuitry that is configured to provide the functionality of the sidecar apparatus 10. For example, the sidecar apparatus 10 of FIGS. 1a and 1c, and of first and second sidecar apparatuses 10a; 10b of FIG. 1d, comprises (optional) interface circuitry 12, processing circuitry 14, memory circuitry 16 and (optional) storage circuitry 18. For example, the processing circuitry 14 may be coupled with the interface circuitry 12, with the memory circuitry 16 and with the storage circuitry 18. For example, the processing circuitry 14 may be configured to provide the functionality of the sidecar apparatus 10, in conjunction with the interface circuitry 12 (for exchanging information, e.g., with other components of the computer system or outside the computer system, such further sidecar apparatuses or devices, software application containers 102, hardware resources 104, or a resource management controller 20), the memory circuitry 16 (for temporarily storing information, such as machine-readable instructions) and the storage circuitry 18 (for permanently or semi-permanently storing information, such as the machine-readable instructions). Likewise, the sidecar device 10 may comprise means that is/are configured to provide the functionality of the sidecar device 10. The components of the sidecar device 10 are defined as component means, which may correspond to, or implemented by, the respective structural components of the sidecar apparatus 10. For example, the sidecar device 10; 10a; 10b of FIGS. 1a, lc and 1d comprises means for processing 14, which may correspond to or be implemented by the processing circuitry 14, (optional) means for communicating 12, which may correspond to or be implemented by the interface circuitry 12, memory 16, which may correspond to or be implemented by the memory circuitry 16 and (optional) means for storing information (i.e., storage) 18, which may correspond to or be implemented by the storage circuitry 18. In general, the functionality of the processing circuitry 14 or means for processing 14 may be implemented by the processing circuitry 14 or means for processing 14 executing machine-readable instructions. Accordingly, any feature ascribed to the processing circuitry 14 or means for processing 14 may be defined by one or more instructions of a plurality of machine-readable instructions. The sidecar apparatus 10 or sidecar device 10 may comprise the plurality of machine-readable instructions, e.g., within the memory circuitry 16 or memory 16 or within the storage circuitry 18 or means for storing information 18.

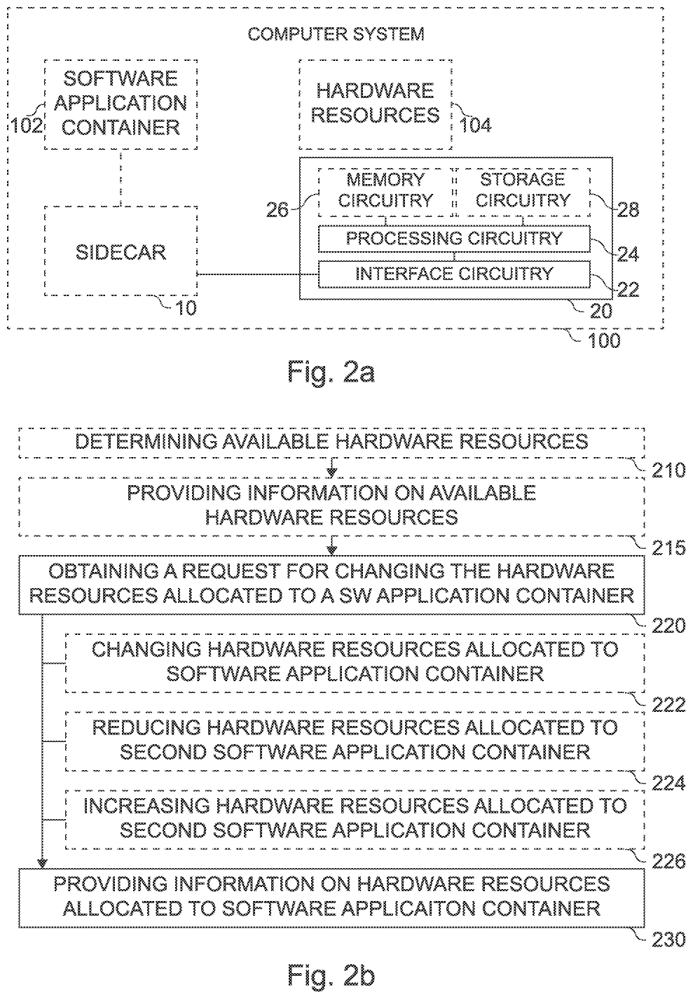

In the following, two aspects will be introduced—in the first aspect, shown in FIGS. 1a, 1b, 1d and 2a, the sidecar apparatus 10; 10a or sidecar device 10; 10a is an entity requesting resources on behalf of a (first) software container apparatus. In a second aspect, shown in FIG. 1d, the sidecar apparatus 10b or sidecar device 10b in an entity receiving such a request from another sidecar entity. In examples, the respective sidecar apparatus or sidecar device may be capable of either or both of these roles.

In a first aspect, the processing circuitry 14 or means for processing 14 is configured to obtain information on hardware resources desired by a software application container 102a from the software application container. In the first aspect, the processing circuitry 14 or means for processing 14 is configured to provide a request for changing the hardware resources allocated to the software application container to another entity 10b, 20 capable of influencing an allocation of hardware resources to the software application container.

FIG. 1b shows a flow chart of an example of a corresponding (computer-implemented) method (for the first aspect) for a software application container sidecar (e.g., the sidecar apparatus 10a or sidecar device 10; 10a). The method comprises obtaining 110 information on the hardware resources desired by the software application container from the software application container. The method comprises providing 130 a request for changing the hardware resources allocated to the software application container to another entity capable of influencing an allocation of hardware resources to the software application container.

In the following, the functionality of the sidecar apparatus 10; 10a; 10b, the sidecar device 10a; 10b, the sidecar method and of a corresponding computer program is illustrated with respect to the sidecar apparatus 10; 10a; 10b. Features introduced in connection with the sidecar apparatus 10; 10a; 10b may likewise be included in the corresponding sidecar device 10; 10a; 10b, sidecar method and computer program.

In the following, the first aspect will be discussed, where the sidecar apparatus (also denoted sidecar in the following) requests a change in hardware resources on behalf of the software application container 102; 102a that is associated with the sidecar apparatus.

In the first aspect, the processing circuitry is configured to obtain the information on the hardware resources desired by a software application container from the software application container, and to provide a corresponding request for changing the hardware resources allocated to the software application container to another entity capable of influencing an allocation of hardware resources to the software application container. For example, the software application container may most a microservice, i.e., a service with limited functionality that is used as part of a larger mesh of services. Such a microservice is a (self-contained) software application that is executed in a runtime environment, e.g., a runtime environment within a software container (or a so-called pod, which is software container with some additional environment) or a runtime environment within a virtual machine. In the present application, the term “software application container” may relate to the runtime environment of a software application providing a microservice, e.g., to one or more of a software container, a pod, and a virtual machine, providing such a runtime environment. For example, the sidecar may be an intermediary between the software application container, and thus the microservice, and the other entity. The sidecar may provide an API (Application Programming Interface) that allows the software application container to indicate the hardware resources being desired by the software application container. In other words, the processing circuitry may be configured to provide an API for obtaining the information on the hardware resources desired by the software application container. For example, whenever the software application container requires additional (or fewer) resources, it may provide updated information on the hardware resources desired by the software application container to the sidecar, e.g., via the API. Accordingly, the information on the hardware resources desired by the software application container may comprise information on a change in the hardware resources desired by the software application container. In particular, the information on the hardware resources desired by the software application container may comprise one of a request for additional hardware resources (to be allocated to the software application container), a command for reducing the hardware resources (being currently allocated to the software application container), a request for additional hardware resources after a pre-defined time interval, a command for reducing the hardware resources after a pre-defined time interval, a request for exchanging hardware resources, and a request for exchanging hardware resources after a pre-defined time interval.

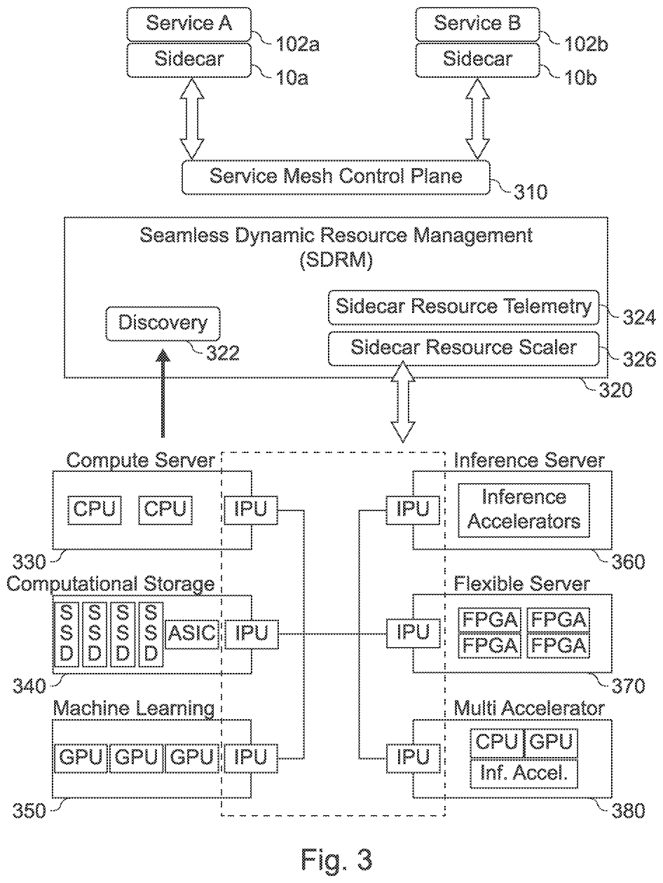

In the context of the present disclosure, the hardware resources may be various. For example, the hardware resources may be provided by the computer system 100 or by another computer system (as shown in FIG. 3, for example). For example, the hardware resources may comprise one or more of central processing unit (CPU) resources, graphics processing unit (GPU) resources, memory resources, storage resources, machine-learning accelerator resources, and field-programmable gate array (FPGA) resources. For example, at least some hardware resources may be XPU hardware resources, which may be provided by accelerator cards (e.g., GPU cards, FPGA cards, AI/machine-learning accelerator cards etc.) hosted by the computer system 100 or by one or more other computer systems.

In some cases, it may be beneficial to be aware of the hardware resources being available, e.g., so the request can be adjusted according to the hardware resources being available. For example, a discovery process may be used to discover the hardware resources that are available. For example, this discovery process may involve obtaining (e.g., receiving) information on the available hardware resource from the other entity. In other words, the processing circuitry may be configured to obtain the information on hardware resources that are available for allocation to the software application container (e.g., from the other entity or from a computer system providing the respective hardware resources). Accordingly, the method may comprise obtaining 125 information on hardware resources that are available for allocation to the software application container. The request for changing the hardware resources may then be provided based on the information on the available hardware resources.

This information may be obtained by requesting said information from the other entity, and/or by using a publish-subscribe scheme, for example. For example, the processing circuitry may be configured to request the information on the available hardware resources from the other entity. Accordingly, the method may comprise requesting 120 the information on the available hardware resources from the other entity. Alternatively, or additionally, the information on the available hardware resources may be obtained via a publish-subscribe scheme.

In the proposed concept, two different other entities are proposed. However, the proposed concept is not limited to the two other entities introduced in the following. In a first variant, a centralized approach may be used, where the other entity is a central resource management controller. In other words, as shown in FIG. 1c, the other entity may be a resource management controller 20 for controlling the allocation of hardware resources to a plurality of software application containers 102. For example, the computer system 100 may further comprise the resource management controller 20, or the resource management controller 20 may be separate from the computer system 100 (as shown in FIG. 1c). FIG. 1c shows a schematic diagram of an example of an interaction between the sidecar apparatus 10 and the resource management controller 20. Alternatively, in a second variant, a peer-to-peer approach may be used, where two sidecars allocate hardware resources in a mutually beneficial manner. In other words, as shown in FIG. 1d, the other entity may be a second sidecar apparatus 10b associated with a second software application container 102b. For example, as shown in FIG. 1d, the computer system 100 may further comprise the second sidecar apparatus 10b, or the second sidecar apparatus 10b may be separate from the computer system 100, e.g., part of another computer system (not shown). FIG. 1d shows a schematic diagram of an example of an interaction between the sidecar apparatus 10a and a second sidecar apparatus 10b or sidecar device 10b. More details on the sidecar apparatus being the requestee will be given in connection with the aforementioned second aspect of the sidecar apparatus. Both the resource controller apparatus and the second sidecar apparatus are entities that are capable of influencing the allocation of hardware resources to the software application container, as will become evident. For example, the processing circuitry may be configured to to select one of the resource management controller and the second sidecar apparatus, e.g., based on a pre-defined selection policy. In other words, the method may comprise selecting one of the resource management controller and the second sidecar apparatus. For example, the sidecar (or sidecars) can be forced to communicate with the centralized resource controller apparatus for scaling. This can be configured via a pre-defined policy.

The request is then provided to the other entity. The request is based on the hardware resources desired by the software application container, and optionally based on the available hardware resources. It may thus mirror the information on the hardware resources desired by the software application container, with some optional adjustments based on the availability of the hardware resources. Accordingly, the request for changing the hardware resources allocated to the software application container may comprise one of a request for additional hardware resources (which may be applicable to both entities), a request for additional hardware resources after a pre-defined time interval (which may be applicable to both entities), a command for reducing the hardware resources (e.g., for the resource management controller), a command for reducing the hardware resources after a pre-defined time interval (e.g., for the resource management controller), information on hardware resources becoming available for a second software application container (e.g., for the second sidecar apparatus) and information on hardware resources becoming available for a second software application container after a pre-defined time interval (e.g., for the second sidecar apparatus), a request for exchanging hardware resources (which may be applicable to both entities), and a request for exchanging hardware resources after a pre-defined time interval.

In general, the hardware resources may already be bound by being allocated to different software application containers. The proposed concept may, in such cases, be used to shift hardware resources between software application containers. This may involve negotiations with the other entity, in particular if the other entity is the second sidecar apparatus. In other words, the processing circuitry may be configured to negotiate the request for changing the hardware resources with the other entity, with the other entity being a second sidecar apparatus. Accordingly, the method may comprise negotiating 135 the request for changing the hardware resources with the other entity. In cases where there is an elasticity aspect between resource usage and performance (e.g., if twice the memory gives 10% better performance), a currency (e.g., dollar) cost-of-resource component tracking against a total cost budget (this in turn can be a cost-performance curve, or just cost minimization or a cost ceiling to track against) may be used to facilitate resource growth or shrinkage decisions. The currency cost can also be replaced by power in the above example. Therefore, the negotiation may be conducted based on a cost function, for example. In other words, the processing circuitry may be configured to negotiate the request for changing the hardware resources with the other entity based on the cost function. For example, the cost function may be based on a performance attainable by using a hardware resource and a (fictional) monetary or power cost of attaining said functions through usage of the resources. For example, the respective monetary cost or power cost may be deducted from a power budget or (fictional) monetary budget set for the respective software application container.

In general, room for negotiation can be provided by re-allocating resources that are over-allocated. As part of the negotiation, a percentage of resources can be included that are over-allocated for any utilization spikes that can be reclaimed based on real-time usage telemetry for allocation to the respective software application container. Accordingly, the processing circuitry may be configured to determine hardware resources that are over-allocated to the software application container based on telemetry of the software application container (e.g., by monitoring the software application container). The processing circuitry may be configured to negotiate based on the hardware resources that are over-allocated to the software application container. The same holds true for the second sidecar apparatus and the second software application container.

Additionally, if the negotiation occurs between two sidecar apparatus, such power budget or (fictional) monetary budget may be moved between software application containers on a temporary basis, e.g., to allow one of the software application containers access temporary access to additional hardware resources, in exchange for reciprocal measures at some other time. To avoid one of the sidecar apparatuses reneging on terms negotiated, such negotiations may be conducted via an immutable resources, such as a distributed ledger (e.g., a blockchain). For example, the processing circuitry may be configured to negotiate the request for changing the hardware resources with the second sidecar apparatus via a distributed ledger, such as via a smart contract being executed on the distributed ledger. For example, the smart contract may control the temporary allocation of hardware resources between the two software application containers associated with the respective sidecar apparatus.

In some examples, machine learning may be used to support the operation of the sidecar apparatus (and/or of the second sidecar apparatus). For example, machine-learning may be applied to improvise the resource scaling and negotiations with the software application containers, e.g., via SLAs. Accordingly, the processing circuitry may be configured to to negotiate the request for changing the hardware resources with the other entity using a machine-learning model. For example, the machine-learning model may be trained to output information on hardware resources to be requested based on the hardware resources desired by the software application container and based on hardware resources desired by the second software application container. For example, a reinforcement learning-based approach may be used to train such a machine-learning model, with a reward function that is based on increasing the performance of two software application containers, with the agents allocating the available hardware resources between the software application containers. Additionally, the processing circuitry may be configured to determine a predicted change in the hardware resources desired by the software application container based on the change in the hardware resources desired by the software application container, and to provide the request based on the predicted change. In this case, the machine-learning model may be trained to perform time-series prediction, to determine the predicted change in the hardware resources desired by the software application container based on the current change in the hardware resources desired by the software application container.

Once the request has been processed, the software application container may be allocated a different set of hardware resources (e.g., fewer, or additional hardware resources). To give the software application container access to the different set of hardware resources, information on these hardware resources may be provided from the other entity to the sidecar apparatus, and from the sidecar apparatus to the software application container (e.g., via the aforementioned API). In various examples, the processing circuitry may be configured to obtain information on hardware resources allocated to the software application container from the other entity in response to the request. This information on hardware resources allocated to the software application container may comprise information on hardware resource being newly allocated to, or withheld from, the software application container. The sidecar apparatus may then make this information available to the software application container. For example, the processing circuitry may be configured to provide information on the hardware resources allocated to the software application container to the software application container. Accordingly, the method may comprise providing 150 information on the hardware resources allocated to the software application container to the software application container.

In some examples, the sidecar apparatus may further serve the purpose of logging (e.g., storing) the hardware resources being allocated to the respective software application container. For example, some examples further provide an attestation capability, e.g., on traces or secure meta-data. For instance, if a service gets a trace of an execution of a microservice with multiple gRPC (a remote procedure call implementation) calls and multiple IP (Intellectual Property Block) crosses, each IP may potentially add secure and signed telemetry. The signature may be used by the software stack to validate that each portion of the trace is generated by a trusted party. Therefore, the processing circuitry may be configured to store (e.g., log) information on the hardware resources allocated to the software application container over time, and to provide the information on the hardware resources allocated to the software application container in signed or encrypted form, e.g., via a distributed ledger. Accordingly, the method may comprise storing 160 information on the hardware resources allocated to the software application container over time and providing 165 the information on the hardware resources allocated to the software application container in signed or encrypted form. This may be used to generate and provide secure telemetry, e.g., for remote tracing/debugging applications.

In the following, the second aspect (i.e., a second sidecar apparatus being the requestee) will be discussed in more detail. In the second aspect (shown in FIG. 1d, for example), the processing circuitry 14 (or means for processing 14) of the second sidecar apparatus 10b is configured to obtain a request for changing the hardware resources allocated to a first software application container 102a (e.g., the aforementioned software application container 102) from the first sidecar apparatus 10a. The second sidecar apparatus is associated with a second software application container 102b being different from the first software application container 102. The processing circuitry 14 (or means for processing 14) of the second sidecar apparatus 10b is configured to provide information on hardware resources allocated to the first software application container to the first sidecar apparatus in response to the request.

FIG. 1e shows a flow chart of an example of a corresponding second (computer-implemented) method for the second software application container sidecar. The second method comprises obtaining 180 the request for changing the hardware resources allocated to the first software application container from the first software application container sidecar. The second method comprises providing 190 the information on hardware resources allocated to the first software application container to the first software application container sidecar in response to the request.

The second aspect relates to the scenario wherein the first sidecar apparatus and the second sidecar apparatus allocate the hardware resources to the respective software application containers in a peer-to-peer manner. In this scenario, both sidecar apparatuses may be capable of allocating limited hardware resources. Some of the hardware resources that can be allocated by the respective sidecar apparatuses can be allocated to other software application containers that are not associated with the respective sidecar apparatus, i.e., the hardware resources may be lent out to another sidecar apparatus for use by the software application container associated with the other sidecar apparatus. For example, any hardware resources allocated to another software application container may be taken away from the software application container associated with the respective sidecar apparatus.

In preparation of the re-allocation of hardware resources, the second sidecar apparatus may provide information on available hardware resources to the first sidecar apparatus, e.g., upon request, or using the aforementioned publish-subscribe scheme. For example, the processing circuitry of the second sidecar apparatus may be configured to provide information on hardware resources being available for allocation to the first software application container. Accordingly, as further shown in FIG. 1c, the second method may comprise providing 170 the information on the hardware resources being available for allocation to the first software application container. For example, the information on the hardware resources being available for allocation to the first software application container may be based on a difference between hardware resources allocated to the second software application container and hardware resources desired or required by the second software application container. The request for the change in hardware resources may then be obtained (e.g., received) in response to the information on the available hardware resources to the first software application container.

In general terms, the processing circuitry of the second sidecar apparatus may be configured to adjust the hardware resources used by the second software application container in response to the request for changing the hardware resources allocated to the first software application container. Accordingly, the second method may comprise adjusting 184 the hardware resources used by the second software application container in response to the request for changing the hardware resources allocated to the first software application container. The processing circuitry of the second sidecar apparatus may be configured to provide the information on the hardware resources allocated to the first software application container based on the hardware resources used by the second software application container after the adjustment. In particular, the hardware resources allocated to the second software application container may be reduced, so additional hardware resources can be allocated to the first software application container. For example, the processing circuitry of the second sidecar apparatus may be configured to reduce the hardware resources used by the second software application container. Accordingly, as further shown in FIG. 1e, the second method may comprise reducing 186 the hardware resources used by the second software application container. This reduction may be performed a) if the request for changing the hardware resources allocated to the first software application container comprises a request for additional hardware resources and b) if more hardware resources are allocated to the second application container than required or desired by the second software application container. In other words, hardware resources might (only) be re-allocated from the second software application container to the first software application container if they can be spared by the second software application container.

In some cases, the first software application container may be allocated more hardware resources than required or desired by the first software application container, so some of the hardware resources may be re-allocated (e.g., given back, or re-allocated to build up some “credit” for future re-allocations from the second software application container to the first software application container) to the second software application container with no or little loss in performance to the first software application container. For example, the processing circuitry of the second sidecar apparatus may be configured to increase the hardware resources used by the second software application container. Accordingly, as further shown in FIG. 1e, the second method may comprise increasing 188 the hardware resources used by the second software application container. This increase may be performed if a) the request for changing the hardware resources allocated to the first software application container comprises one of information on hardware resources becoming available for the second software application container and information on hardware resources becoming available for the second software application container after a pre-defined time interval and b) if fewer hardware resources are allocated to the second application container than desired by the second software application container.

As outlined in connection with the first aspect, the mutual re-allocation of hardware resources may be negotiated between the sidecar apparatus, e.g., based on the cost function, using a machine-learning model, and/or via a distributed ledger, such as via a smart contract being executed on the distributed ledger. For example, the processing circuitry of the second sidecar apparatus may be configured to negotiate the request for changing the hardware resources with the first sidecar apparatus. Accordingly, as further shown in FIG. 1e, the second method may comprise negotiating 182 the request for changing the hardware resources with the first software application container sidecar.

The proposed concept may provide an improved provenance tracking with auditability, secure revocation, XPU (X Processing Unit, where X stands for various types of accelerator)/microservices on-boarding/off-boarding management, and improved intellectual property confidentiality.

The interface circuitry 12 or means for communicating 12 may correspond to one or more inputs and/or outputs for receiving and/or transmitting information, which may be in digital (bit) values according to a specified code, within a module, between modules or between modules of different entities. For example, the interface circuitry 12 or means for communicating 12 may comprise circuitry configured to receive and/or transmit information.

For example, the processing circuitry 14 or means for processing 14 may be implemented using one or more processing units, one or more processing devices, any means for processing, such as a processor, a computer or a programmable hardware component being operable with accordingly adapted software. In other words, the described function of the processing circuitry 14 or means for processing may as well be implemented in software, which is then executed on one or more programmable hardware components. Such hardware components may comprise a general-purpose processor, a Digital Signal Processor (DSP), a micro-controller, etc.

For example, the memory circuitry 16 or memory 16 may comprise volatile or non-volatile memory, e.g., circuitry for providing volatile or non-volatile memory. For example, the memory circuitry or memory 16 may be random-access memory (RAM), such as dynamic random-access memory (DRAM) or static random-access memory (SRAM), or persistent memory (PMEM). For example, at least a portion of the memory circuitry may be part of the processing circuitry, e.g., registers of the processing circuitry.

For example, the storage circuitry 18 or means for storing information 18 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

For example, the computer system 100 may be a workstation computer system (e.g., a workstation computer system being used for scientific computation).

More details and aspects of the sidecar apparatuses 10; 10a; 10b, sidecar devices 10; 10a; 10b, methods, computer programs and computer system 100 are mentioned in connection with the proposed concept or one or more examples described above or below (e.g., FIGS. 2a to 4). The sidecar apparatuses 10; 10a; 10b, sidecar devices 10; 10a; 10b, methods, computer programs and computer system 100 may comprise one or more additional optional features corresponding to one or more aspects of the proposed concept, or one or more examples described above or below.

FIG. 2a shows a schematic diagram of an example of a resource management controller apparatus 20 or resource management controller device 20, and of a computer system 200 (e.g., the computer system 200 shown in connection with FIGS. 2a to 2e) comprising such a resource management controller apparatus 20 or resource management controller device 20. The resource management controller apparatus 20 comprises circuitry that is configured to provide the functionality of the resource management controller apparatus 20. For example, the resource management controller apparatus 20 of FIG. 2a comprises (optional) interface circuitry 22, processing circuitry 24, memory circuitry 26 and (optional) storage circuitry 28. For example, the processing circuitry 24 may be coupled with the interface circuitry 22, with the memory circuitry 26 and with the storage circuitry 28. For example, the processing circuitry 24 may be configured to provide the functionality of the resource management controller apparatus 20, in conjunction with the interface circuitry 22 (for exchanging information, e.g., with other components of the computer system or outside the computer system, such as a sidecar apparatus or device 10 or hardware resources 104), the memory circuitry 26 (for temporarily storing information, such as machine-readable instructions) and the storage circuitry 28 (for permanently or semi-permanently storing information, such as the machine-readable instructions). Likewise, the resource management controller device 20 may comprise means that is/are configured to provide the functionality of the resource management controller device 20. The components of the resource management controller device 20 are defined as component means, which may correspond to, or implemented by, the respective structural components of the resource management controller apparatus 20. For example, the resource management controller device 20 of FIG. 2a comprises means for processing 24, which may correspond to or be implemented by the processing circuitry 24, (optional) means for communicating 22, which may correspond to or be implemented by the interface circuitry 22, memory 26, which may correspond to or be implemented by the memory circuitry 26 and (optional) means for storing information (i.e., storage) 28, which may correspond to or be implemented by the storage circuitry 28. In general, the functionality of the processing circuitry 24 or means for processing 24 may be implemented by the processing circuitry 24 or means for processing 24 executing machine-readable instructions. Accordingly, any feature ascribed to the processing circuitry 24 or means for processing 24 may be defined by one or more instructions of a plurality of machine-readable instructions. The resource management controller apparatus 20 or resource management controller device 20 may comprise the plurality of machine-readable instructions, e.g., within the memory circuitry 26 or memory 26 or within the storage circuitry 28 or means for storing information 28.

The processing circuitry 24 or means for processing 24 is configured to obtain a request for changing the hardware resources allocated to a software application container 102 from the sidecar apparatus 10 or sidecar device 10 (also denoted software application container sidecar in the following). The processing circuitry 24 or means for processing 24 is configured to provide information on hardware resources allocated to the software application container to the sidecar apparatus or device in response to the request.

FIG. 2b shows a flow chart of an example of a corresponding (computer-implemented) resource management controller method. The resource management controller method comprises obtaining 220 the request for changing the hardware resources allocated to the software application container from the software application container sidecar. The resource management controller method comprises providing 230 information on hardware resources allocated to the software application container to the software application container sidecar in response to the request.

In the following, the functionality of the resource management controller apparatus 20, the resource management controller device 20, the resource management controller method and of a corresponding computer program is illustrated with respect to the resource management controller apparatus 20. Features introduced in connection with the resource management controller apparatus 20 may likewise be included in the corresponding resource management controller device 20, resource management controller method and computer program.

As outlined in connection with FIGS. 1a to 1e, in some examples, the hardware resource allocation is performed by the resource management controller, which is configured to control the allocation of hardware resources to a plurality of software application containers, with the (first) software application container associated with the sidecar apparatus being among the plurality of software application containers. While the allocation or re-allocation of hardware resources between software application container sidecars is based on a peer-to-peer approach, the resource management controller represents a centralized approach, where the resource management controller allocates, as a central entity, the hardware resources to the different software application containers.

As outlined in connection with FIGS. 1a to 1e, in some examples, it may be beneficial if the software application container sidecars are aware of the hardware resources that can potentially be allocated to the respective software application containers. Therefore, the resource management controller may determine such hardware resources a priori and supply the software application container sidecar with the respective information. For example, the processing circuitry may be configured to determine hardware resources being available for allocation to the software application container. Accordingly, the method may comprise determining 210 the hardware resources being available for allocation to the software application container. For example, the information on the hardware resources that are available for the software application container may be determined based on a difference between hardware resources allocated to one or more second software application containers and hardware resources desired or required by the one or more second software application containers. For example, the processing circuitry may monitor a use of the hardware resources by the software application containers to determine telemetry of the use of the hardware resources, and to determine the information on the hardware resources that are available for the software application container, e.g., the difference between hardware resources allocated to one or more second software application containers and hardware resources desired or required by the one or more second software application containers, based on the telemetry. For example, scaleup/out telemetry from the sidecar (e.g., the use of hardware resources over time) may be captured for closed loop feedback for future resource improvements/allocation/reservation or placement strategy for microservices. These available hardware resources may then be communicated to the software application container sidecar and may form the basis for the allocation of hardware resources to the software application container. Thus, the processing circuitry may be configured to provide information on hardware resources that are available for allocation to the software application container to the software application container sidecar. Accordingly, the method may comprise providing 215 information on hardware resources that are available for allocation to the software application container to the software application container sidecar, with the request being obtained in response to the information on the available hardware resources to the software application container. This information may enable the software application container sidecar to prepare the request for the changing the hardware resources allocated to the software application container. Accordingly, the request may be obtained in response to the information on the available hardware resources to the software application container. Consequently, the allocation of the hardware resources, and thus the provided information on the hardware resources allocated to the software application container, may also be based on the available hardware resources.

The processing circuitry is configured to obtain the request for changing the hardware resources allocated to a software application container from the software application container sidecar. This request is processed by the resource management controller, and the hardware resources are allocated accordingly. For example, the processing circuitry may be configured to allocate the hardware resources to the (first) software application container (and the one or more second software application containers) based on the request, e.g., based on at least one of a cost function and telemetry information on a use of hardware resources by software application containers. For example, the processing circuitry may be configured to take into account the cost functions of the (first) software application container and of one or more second software application containers. Again, the cost function may be based on a performance attainable, by the respective software application container, by using a hardware resource and a (fictional) monetary or power cost of attaining said functions through usage of the resources. For example, the respective monetary cost or power cost may be deducted from a power budget or (fictional) monetary budget set for the respective software application container. The telemetry information may be used to determine the hardware resources being used (currently or historically) by the software application container and by the one or more software application containers. For example, the processing circuitry may be configured to change the hardware resources allocated to the (first) software application container (and, optionally, to the one or more second software application containers) based on the request. Accordingly, as further shown in FIG. 2b, the method may comprise changing 222 the hardware resources allocated to the (first) software application container (and to the one or more second software application containers, for example).

In some examples, if the software application container desires additional hardware resources, the hardware resources being additionally allocated to the (first) software application container may be previously unused/unallocated. However, in some cases, all of the hardware resources may be previously allocated. In this case, some hardware resources may be re-allocated from a second software application container to the (first) software application container. For example, the processing circuitry may be configured to reduce the hardware resources allocated to a second software application container. Accordingly, as further shown in FIG. 2b, the method may comprise reducing 224 the hardware resources allocated to a second software application container. This reduction may be performed if the request for changing the hardware resources allocated to the software application container may comprise a request for additional hardware resources and if more hardware resources are allocated to the second application container than required or desired by the second software application container.

In some cases, however, the request for changing the hardware resources allocated to the software application container may comprise a command for reducing the hardware resources or a command for reducing the hardware resources after a pre-defined time interval. If this is the case, the previously allocated hardware resources may be freed (e.g., unallocated) or reallocated to another software application container (i.e., a second software application container). For example, the processing circuitry may be configured to increase hardware resources allocated to a second software application container. Accordingly, as further shown in FIG. 2b, the method comprises increasing 226 hardware resources allocated to a second software application container. This increase may be performed if the request for changing the hardware resources allocated to the software application container comprises one of a command for reducing the hardware resources and a command for reducing the hardware resources after a pre-defined time interval and if fewer hardware resources are allocated to the second application container than desired by the second software application container.

Once the hardware resources are (re-) allocated, the software application container sidecar may be informed accordingly, by providing the information on hardware resources (now) allocated to the software application container to the sidecar apparatus in response to the request.

The interface circuitry 22 or means for communicating 22 may correspond to one or more inputs and/or outputs for receiving and/or transmitting information, which may be in digital (bit) values according to a specified code, within a module, between modules or between modules of different entities. For example, the interface circuitry 22 or means for communicating 22 may comprise circuitry configured to receive and/or transmit information.

For example, the processing circuitry 24 or means for processing 24 may be implemented using one or more processing units, one or more processing devices, any means for processing, such as a processor, a computer or a programmable hardware component being operable with accordingly adapted software. In other words, the described function of the processing circuitry 24 or means for processing may as well be implemented in software, which is then executed on one or more programmable hardware components. Such hardware components may comprise a general-purpose processor, a Digital Signal Processor (DSP), a micro-controller, etc.

For example, the memory circuitry 26 or memory 26 may comprise volatile or non-volatile memory, e.g., circuitry for providing volatile or non-volatile memory. For example, the memory circuitry or memory 26 may be random-access memory (RAM), such as dynamic random-access memory (DRAM) or static random-access memory (SRAM), or persistent memory (PMEM). For example, at least a portion of the memory circuitry may be part of the processing circuitry, e.g., registers of the processing circuitry.

For example, the storage circuitry 28 or means for storing information 28 may comprise at least one element of the group of a computer readable storage medium, such as a magnetic or optical storage medium, e.g., a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

More details and aspects of the resource management controller apparatus 20, resource management controller device 20, resource management controller method and computer program are mentioned in connection with the proposed concept, or one or more examples described above or below (e.g., FIG. 1a to 1e, 3 to 4). The resource management controller apparatus 20, resource management controller device 20, resource management controller method and computer program may comprise one or more additional optional features corresponding to one or more aspects of the proposed concept, or one or more examples described above or below.

FIG. 3 shows a high-level schematic diagram of an example of a system architecture of the proposed SDRM. FIG. 3 shows two services/microservices 102a; 102b with respective associated sidecars 10a; 10b (e.g., sidecar apparatuses or devices as introduced in connection with FIGS. 1a to 1e), which communicate via a service mesh control plane. The proposed SDRM 320, which may be implemented by the respective sidecar apparatuses or devices of FIGS. 1a to 1e and/or the resource management controller apparatuses or devices of FIGS. 2a to 2b, may comprise a discovery component 322, a sidecar resource telemetry component 324 and a sidecar resource scaler component 326. For example, through the discovery component 322, various resourcing services in the infrastructure (pooled memory, distributed storage, computational resources available for in-network-compute, etc.) may be made available by registration through infrastructure services. Application sidecars forwarding requests from microservices to the sidecar resource scaler 326 and pooling services. The client microservices may obtain various dynamically pooled resources and automatically expand or shrink and release non-needed capacities through the sidecars. For example, such pooled (hardware) resources may include CPU resources provided by a compute server 330, SSD (Solid-State Drive) storage provided by a computational storage server 340 comprising SSDs and Application-Specific Integrated Circuitry (ASIC), GPU resources provided by a machine-learning server 350, inference accelerator resources provided by an inference server 360, FPGA resources provided by a flexible server 370 and/or different types of accelerator resources (CPU, GPU, inference accelerator) provided by a multi-accelerator server 380. The respective servers (including the server hosting the microservices) may be connected via infrastructure processing units (IPU, a programmable network device) and a computer network. The sidecars may provide an API to the client application's software to provide a try-and-grow, grow-after-time-X, shrink, shrink-after-time-X, replace, or replace-after-time-X APIs so that the sidecars can obtain, schedule, and return the pooled resources (i.e., the hardware resources). This may happen without the application software having to be platform software conscious or having to know what is available where. For example, the proposed concept may be used for ad-hoc use of expensive resources like AI accelerators, FPGA slices, ephemeral storage, memory for mature cold objects, memory for denormalized database tables, higher latency but higher capacity network slices, etc.

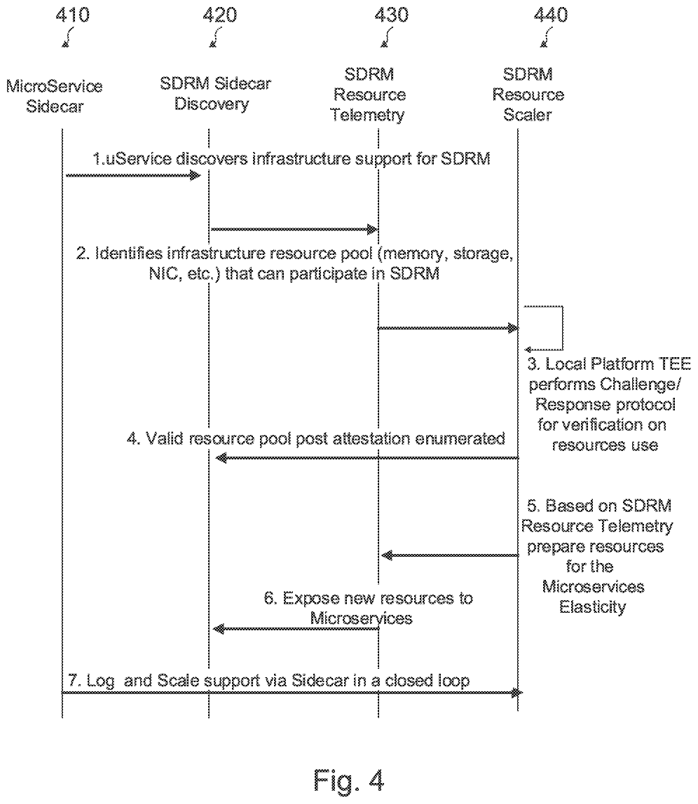

FIG. 4 shows a flow chart of an example of an operational flow involving some major components discussed above. The flow of FIG. 4 comprises the entities MicroService Sidecar 410 (e.g., the sidecar apparatus or device 10; 10a; 10b introduced in connection with FIGS. 1a to 1e), SDRM sidecar discovery 320 (which may be performed by the sidecar apparatus or device 10; 10a; 10b or by the resource management controller 20 of FIGS. 2a to 2b), SDRM resource telemetry 430 (which may be performed by the sidecar apparatus or device 10; 10a; or by the resource management controller 20 of FIGS. 2a to 2b), and SDRM resource scaler 440 (which may be performed by the sidecar apparatus or device 10b or by the resource management controller 20 of FIGS. 2a to 2b). At 1) the microservice (e.g., the software application container 102; 102a of FIGS. 1a to 1e) discovers infrastructure support for SDRM (via the microservice sidecar 410 and the SDRM sidecar discovery) At 2), the SDRM sidecar discovery 420 identifies the infrastructure resource pool (memory, storage, NIC (Network Interface Card/Chip) etc.), i.e., the hardware resources that can participate in SDRM, using the SDRM resource telemetry 430. At 3), the SDRM resource scaler 440, e.g., a local platform trusted execution environment, performs a challenge/response protocol for verification on resources use. At 4), the SDRAM resource scaler 440 may give feedback to the SDRM sidecar discovery that a valid resource pool post attestation is enumerated. At 5), based on the SDRM resource telemetry, the SDRM resource scaler 440 prepares resources for the microservice elasticity, and provides the respective information to the SDRM resource telemetry 430, which, at 6) exposes the new resources to the microservices. At 7), the resources may be logged and scaling support many be provided via the sidecar in a closed between the microservice sidecar 410 and the SDRM resource scaler 440.

More details and aspects of the SDRM are mentioned in connection with the proposed concept or one or more examples described above or below (e.g., FIG. 1a to 2b). The SDRM may comprise one or more additional optional features corresponding to one or more aspects of the proposed concept, or one or more examples described above or below.

In the following, some examples of the proposed concept are given.

An example (e.g., example 1) relates to a sidecar apparatus (10, 10a) comprising interface circuitry (12), machine-readable instructions and processing circuitry (14) to execute the machine-readable instructions to obtain information on hardware resources desired by a software application container (102a) from the software application container. The machine-readable instructions comprise instructions to provide a request for changing the hardware resources allocated to the software application container to another entity (10b, 20) capable of influencing an allocation of hardware resources to the software application container.

Another example (e.g., example 2) relates to a previously described example (e.g., example 1) or to any of the examples described herein, further comprising that the other entity is a resource management controller (20) for controlling the allocation of hardware resources to a plurality of software application containers (102).

Another example (e.g., example 3) relates to a previously described example (e.g., one of the examples 1 to 2) or to any of the examples described herein, further comprising that the other entity is a second sidecar apparatus (10b) associated with a second software application container (102b).

Another example (e.g., example 3a) relates to a previously described example (e.g., one of the examples 1 to 3) or to any of the examples described herein, further comprising that the other entity is one of a resource management controller for controlling the allocation of hardware resources to a plurality of software application containers and a second sidecar apparatus associated with a second software application container, with the machine-readable instructions comprising instructions to select one of the resource management controller and the second sidecar apparatus based on a pre-defined selection policy.

Another example (e.g., example 4) relates to a previously described example (e.g., one of the examples 1 to 3a) or to any of the examples described herein, further comprising that the information on the hardware resources desired by the software application container comprises information on a change in the hardware resources desired by the software application container.

Another example (e.g., example 5) relates to a previously described example (e.g., example 4) or to any of the examples described herein, further comprising that the information on the hardware resources desired by the software application container comprises one of a request for additional hardware resources, a command for reducing the hardware resources, a request for additional hardware resources after a pre-defined time interval, a command for reducing the hardware resources after a pre-defined time interval, a request for exchanging hardware resources, and a request for exchanging hardware resources after a pre-defined time interval.

Another example (e.g., example 6) relates to a previously described example (e.g., example 5) or to any of the examples described herein, further comprising that the request for changing the hardware resources allocated to the software application container comprises one of a request for additional hardware resources, a request for additional hardware resources after a pre-defined time interval, a command for reducing the hardware resources, a command for reducing the hardware resources after a pre-defined time interval, information on hardware resources becoming available for a second software application container, information on hardware resources becoming available for a second software application container after a pre-defined time interval, a request for exchanging hardware resources, and a request for exchanging hardware resources after a pre-defined time interval.

Another example (e.g., example 6a) relates to a previously described example (e.g., one of the examples 1 to 6) or to any of the examples described herein, further comprising that the machine-readable instructions comprise instructions to determine a predicted change in the hardware resources desired by the software application container based on the change in the hardware resources desired by the software application container, and to provide the request based on the predicted change.

Another example (e.g., example 7) relates to a previously described example (e.g., one of the examples 1 to 6a) or to any of the examples described herein, further comprising that the machine-readable instructions comprise instructions to obtain information on hardware resources that are available for allocation to the software application container, with the request for changing the hardware resources being provided based on the information on the available hardware resources.

Another example (e.g., example 8) relates to a previously described example (e.g., example 7) or to any of the examples described herein, further comprising that the information on the available hardware resources is obtained via a publish-subscribe scheme.

Another example (e.g., example 9) relates to a previously described example (e.g., one of the examples 7 to 8) or to any of the examples described herein, further comprising that the machine-readable instructions comprise instructions to request the information on the available hardware resources from the other entity.

Another example (e.g., example 10) relates to a previously described example (e.g., one of the examples 1 to 9) or to any of the examples described herein, further comprising that the machine-readable instructions comprise instructions to provide information on the hardware resources allocated to the software application container to the software application container.

Another example (e.g., example 11) relates to a previously described example (e.g., one of the examples 1 to 10) or to any of the examples described herein, further comprising that the machine-readable instructions comprise instructions to negotiate the request for changing the hardware resources with the other entity, the other entity being a second sidecar apparatus, such as

Another example (e.g., example 11a) relates to a previously described example (e.g., example 11) or to any of the examples described herein, further comprising that the machine-readable instructions comprise instructions to negotiate the request for changing the hardware resources with the other entity using a machine-learning model.

Another example (e.g., example 12) relates to a previously described example (e.g., example 11) or to any of the examples described herein, further comprising that the machine-readable instructions comprise instructions to negotiate the request for changing the hardware resources with the second sidecar apparatus via a distributed ledger, such as instructions to negotiate the request for changing the hardware resources with the second sidecar apparatus via a smart contract being executed on the distributed ledger.

Another example (e.g., example 13) relates to a previously described example (e.g., one of the examples 11 to 12) or to any of the examples described herein, further comprising that the machine-readable instructions comprise instructions to negotiate the request for changing the hardware resources with the other entity based on a cost function.

Another example (e.g., example 14) relates to a previously described example (e.g., one of the examples 1 to 13) or to any of the examples described herein, further comprising that the machine-readable instructions comprise instructions to obtain information on hardware resources allocated to the software application container from the other entity in response to the request.

Another example (e.g., example 15) relates to a previously described example (e.g., example 14) or to any of the examples described herein, further comprising that the information on hardware resources allocated to the software application container comprises information on hardware resource being newly allocated to, or withheld from, the software application container.

Another example (e.g., example 16) relates to a previously described example (e.g., one of the examples 1 to 15) or to any of the examples described herein, further comprising that the hardware resources comprise one or more of central processing unit (CPU) resources, graphics processing unit (GPU) resources, memory resources, storage resources, machine-learning accelerator resources, and field-programmable gate array (FPGA) resources.

Another example (e.g., example 17) relates to a previously described example (e.g., one of the examples 1 to 16) or to any of the examples described herein, further comprising that the machine-readable instructions comprise instructions to store information on the hardware resources allocated to the software application container over time, and instructions to provide the information on the hardware resources allocated to the software application container in signed or encrypted form.

Another example (e.g., example 18) relates to a previously described example (e.g., example 17) or to any of the examples described herein, further comprising that the machine-readable instructions comprise instructions to provide the information on the hardware resources being allocated to the software application container in signed or encrypted form via a distributed ledger.

An example (e.g., example 19) relates to a second sidecar apparatus (10b) comprising interface circuitry (12), machine-readable instructions and processing circuitry (14) to execute the machine-readable instructions to obtain a request for changing the hardware resources allocated to a first software application container (102a) from a first sidecar apparatus (10a), the second sidecar apparatus being associated with a second software application container (102b) being different from the first software application container. The machine-readable instructions comprise instructions to provide information on hardware resources allocated to the first software application container to the first sidecar apparatus in response to the request.

Another example (e.g., example 20) relates to a previously described example (e.g., example 19) or to any of the examples described herein, further comprising that the machine-readable instructions comprise instructions to adjust the hardware resources used by the second software application container in response to the request for changing the hardware resources allocated to the first software application container, and to provide the information on the hardware resources allocated to the first software application container based on the hardware resources used by the second software application container after the adjustment.

Another example (e.g., example 21) relates to a previously described example (e.g., example or to any of the examples described herein, further comprising that the machine-readable instructions comprise instructions to reduce the hardware resources used by the second software application container if the request for changing the hardware resources allocated to the first software application container comprises a request for additional hardware resources and if more hardware resources are allocated to the second application container than required or desired by the second software application container.

Another example (e.g., example 22) relates to a previously described example (e.g., one of the examples 20 to 21) or to any of the examples described herein, further comprising that the machine-readable instructions comprise instructions to increase the hardware resources used by the second software application container if the request for changing the hardware resources allocated to the first software application container comprises one of information on hardware resources becoming available for the second software application container and information on hardware resources becoming available for the second software application container after a pre-defined time interval and if fewer hardware resources are allocated to the second application container than desired by the second software application container.

Another example (e.g., example 23) relates to a previously described example (e.g., one of the examples 19 to 22) or to any of the examples described herein, further comprising that the machine-readable instructions comprise instructions to negotiate the request for changing the hardware resources with the first sidecar apparatus.

Another example (e.g., example 23a) relates to a previously described example (e.g., example 23) or to any of the examples described herein, further comprising that the machine-readable instructions comprise instructions to negotiate the request for changing the hardware resources with the first sidecar apparatus using a machine-learning model.

Another example (e.g., example 24) relates to a previously described example (e.g., example 23 or 23a) or to any of the examples described herein, further comprising that the machine-readable instructions comprise instructions to negotiate the request for changing the hardware resources with the first sidecar apparatus via a distributed ledger, such as instructions to negotiate the request for changing the hardware resources with the first sidecar apparatus via a smart contract being executed on the distributed ledger.

Another example (e.g., example 25) relates to a previously described example (e.g., one of the examples 23 to 24) or to any of the examples described herein, further comprising that the machine-readable instructions comprise instructions to negotiate the request for changing the hardware resources with the first sidecar apparatus based on a cost function.

Another example (e.g., example 26) relates to a previously described example (e.g., one of the examples 19 to 25) or to any of the examples described herein, further comprising that the machine-readable instructions comprise instructions to provide information on hardware resources being available for allocation to the first software application container based on a difference between hardware resources allocated to the second software application container and hardware resources desired or required by the second software application container, with the request being obtained in response to the information on the available hardware resources to the first software application container.

An example (e.g., example 27) relates to a resource management controller apparatus (20) comprising interface circuitry (22), machine-readable instructions and processing circuitry (24) to execute the machine-readable instructions to obtain a request for changing the hardware resources allocated to a software application container (102) from a sidecar apparatus (10). The machine-readable instructions comprise instructions to provide information on hardware resources allocated to the software application container to the sidecar apparatus in response to the request.

Another example (e.g., example 28) relates to a previously described example (e.g., example 27) or to any of the examples described herein, further comprising that the machine-readable instructions comprise instructions to determine hardware resources being available for allocation to the software application container, and instructions to provide the information on the hardware resources allocated to the software application container based on the available hardware resources.

Another example (e.g., example 29) relates to a previously described example (e.g., example 28) or to any of the examples described herein, further comprising that the machine-readable instructions comprise instructions to reduce the hardware resources allocated to a second software application container if the request for changing the hardware resources allocated to the software application container comprises a request for additional hardware resources and if more hardware resources are allocated to the second application container than required or desired by the second software application container.

Another example (e.g., example 30) relates to a previously described example (e.g., one of the examples 28 to 29) or to any of the examples described herein, further comprising that the machine-readable instructions comprise instructions to increase hardware resources allocated to a second software application container if the request for changing the hardware resources allocated to the software application container comprises one of a command for reducing the hardware resources and a command for reducing the hardware resources after a pre-defined time interval and if fewer hardware resources are allocated to the second application container than desired by the second software application container.

Another example (e.g., example 31) relates to a previously described example (e.g., one of the examples 27 to 30) or to any of the examples described herein, further comprising that the machine-readable instructions comprise instructions to provide information on hardware resources that are available for allocation to the software application container to the software application container sidecar, with the request being obtained in response to the information on the available hardware resources to the software application container, and instructions to provide the information on the available hardware resources to the software application container based on a difference between hardware resources allocated to one or more second software application containers and hardware resources desired or required by the one or more second software application containers.

Another example (e.g., example 32) relates to a previously described example (e.g., one of the examples 27 to 31) or to any of the examples described herein, further comprising that the machine-readable instructions comprise instructions to allocate the hardware resources to the first software application container and one or more second software application containers based on at least one of a cost function and telemetry information on a use of hardware resources by software application containers.

An example (e.g., example 33) relates to a sidecar apparatus (10, 10a) comprising interface circuitry (12) and processing circuitry (14). The processing circuitry is configured to obtain information on hardware resources desired by a software application container (102a) from the software application container. The processing circuitry is configured to provide a request for changing the hardware resources allocated to the software application container to another entity (10b, 20) capable of influencing an allocation of hardware resources to the software application container.

Another example (e.g., example 34) relates to a previously described example (e.g., example 33) or to any of the examples described herein, further comprising that the other entity is a resource management controller (20) for controlling the allocation of hardware resources to a plurality of software application containers (102).

Another example (e.g., example 35) relates to a previously described example (e.g., one of the examples 33 to 34) or to any of the examples described herein, further comprising that the other entity is a second sidecar apparatus (10b) associated with a second software application container (102b).

Another example (e.g., example 35a) relates to a previously described example (e.g., one of the examples 33 to 35) or to any of the examples described herein, further comprising that the other entity is one of a resource management controller for controlling the allocation of hardware resources to a plurality of software application containers and a second sidecar apparatus associated with a second software application container, with the processing circuitry being configured to select one of the resource management controller and the second sidecar apparatus based on a pre-defined selection policy.

Another example (e.g., example 36) relates to a previously described example (e.g., one of the examples 33 to 35a) or to any of the examples described herein, further comprising that the information on the hardware resources desired by the software application container comprises information on a change in the hardware resources desired by the software application container.

Another example (e.g., example 37) relates to a previously described example (e.g., example 36) or to any of the examples described herein, further comprising that the information on the hardware resources desired by the software application container comprises one of a request for additional hardware resources, a command for reducing the hardware resources, a request for additional hardware resources after a pre-defined time interval, a command for reducing the hardware resources after a pre-defined time interval, a request for exchanging hardware resources, and a request for exchanging hardware resources after a pre-defined time interval.

Another example (e.g., example 38) relates to a previously described example (e.g., example 37) or to any of the examples described herein, further comprising that the request for changing the hardware resources allocated to the software application container comprises one of a request for additional hardware resources, a request for additional hardware resources after a pre-defined time interval, a command for reducing the hardware resources, a command for reducing the hardware resources after a pre-defined time interval, information on hardware resources becoming available for a second software application container, information on hardware resources becoming available for a second software application container after a pre-defined time interval, a request for exchanging hardware resources, and a request for exchanging hardware resources after a pre-defined time interval.

Another example (e.g., example 38a) relates to a previously described example (e.g., one of the examples 33 to 38) or to any of the examples described herein, further comprising that the processing circuitry is configured to determine a predicted change in the hardware resources desired by the software application container based on the change in the hardware resources desired by the software application container, and to provide the request based on the predicted change.

Another example (e.g., example 39) relates to a previously described example (e.g., one of the examples 33 to 38) or to any of the examples described herein, further comprising that the processing circuitry is configured to obtain information on hardware resources that are available for allocation to the software application container, with the request for changing the hardware resources being provided based on the information on the available hardware resources.

Another example (e.g., example 40) relates to a previously described example (e.g., example 39) or to any of the examples described herein, further comprising that the information on the available hardware resources is obtained via a publish-subscribe scheme.

Another example (e.g., example 41) relates to a previously described example (e.g., one of the examples 39 to 40) or to any of the examples described herein, further comprising that the processing circuitry is configured to request the information on the available hardware resources from the other entity.

Another example (e.g., example 42) relates to a previously described example (e.g., one of the examples 39 to 41) or to any of the examples described herein, further comprising that the processing circuitry is configured to provide information on the hardware resources allocated to the software application container to the software application container.

Another example (e.g., example 43) relates to a previously described example (e.g., one of the examples 33 to 42) or to any of the examples described herein, further comprising that the processing circuitry is configured to negotiate the request for changing the hardware resources with the other entity, the other entity being a second sidecar apparatus.

Another example (e.g., example 43a) relates to a previously described example (e.g., example 43) or to any of the examples described herein, further comprising that the processing circuitry is configured to negotiate the request for changing the hardware resources with the other entity using a machine-learning model.

Another example (e.g., example 44) relates to a previously described example (e.g., example 43 or 43a) or to any of the examples described herein, further comprising that the processing circuitry is configured to negotiate the request for changing the hardware resources with the second sidecar apparatus via a distributed ledger, such as via a smart contract being executed on the distributed ledger.

Another example (e.g., example 45) relates to a previously described example (e.g., one of the examples 43 to 44) or to any of the examples described herein, further comprising that the processing circuitry is configured to negotiate the request for changing the hardware resources with the other entity based on a cost function.

Another example (e.g., example 46) relates to a previously described example (e.g., one of the examples 33 to 45) or to any of the examples described herein, further comprising that the processing circuitry is configured to obtain information on hardware resources allocated to the software application container from the other entity in response to the request.

Another example (e.g., example 47) relates to a previously described example (e.g., example 46) or to any of the examples described herein, further comprising that the information on hardware resources allocated to the software application container comprises information on hardware resource being newly allocated to, or withheld from, the software application container.

Another example (e.g., example 48) relates to a previously described example (e.g., one of the examples 33 to 47) or to any of the examples described herein, further comprising that the hardware resources comprise one or more of central processing unit (CPU) resources, graphics processing unit (GPU) resources, memory resources, storage resources, machine-learning accelerator resources, and field-programmable gate array (FPGA) resources.

Another example (e.g., example 49) relates to a previously described example (e.g., one of the examples 33 to 48) or to any of the examples described herein, further comprising that the processing circuitry is configured to store information on the hardware resources allocated to the software application container over time, and to provide the information on the hardware resources allocated to the software application container in signed or encrypted form.

Another example (e.g., example 50) relates to a previously described example (e.g., example 49) or to any of the examples described herein, further comprising that the processing circuitry is configured to provide the information on the hardware resources being allocated to the software application container in signed or encrypted form via a distributed ledger.

An example (e.g., example 51) relates to a second sidecar apparatus (10b) comprising interface circuitry (12) and processing circuitry (14). The processing circuitry is configured to obtain a request for changing the hardware resources allocated to a first software application container (102a) from a first sidecar apparatus (10a), the second sidecar apparatus being associated with a second software application container (102b) being different from the first software application container. The processing circuitry is configured to provide information on hardware resources allocated to the first software application container to the first sidecar apparatus in response to the request.

Another example (e.g., example 52) relates to a previously described example (e.g., example 51) or to any of the examples described herein, further comprising that the processing circuitry is configured to adjust the hardware resources used by the second software application container in response to the request for changing the hardware resources allocated to the first software application container, and to provide the information on the hardware resources allocated to the first software application container based on the hardware resources used by the second software application container after the adjustment.

Another example (e.g., example 53) relates to a previously described example (e.g., example 52) or to any of the examples described herein, further comprising that the processing circuitry is configured to reduce the hardware resources used by the second software application container if the request for changing the hardware resources allocated to the first software application container comprises a request for additional hardware resources and if more hardware resources are allocated to the second application container than required or desired by the second software application container.

Another example (e.g., example 54) relates to a previously described example (e.g., one of the examples 52 to 53) or to any of the examples described herein, further comprising that the processing circuitry is configured to increase the hardware resources used by the second software application container if the request for changing the hardware resources allocated to the first software application container comprises one of information on hardware resources becoming available for the second software application container and information on hardware resources becoming available for the second software application container after a pre-defined time interval and if fewer hardware resources are allocated to the second application container than desired by the second software application container.

Another example (e.g., example 55) relates to a previously described example (e.g., one of the examples 51 to 54) or to any of the examples described herein, further comprising that the processing circuitry is configured to negotiate the request for changing the hardware resources with the first sidecar apparatus.

Another example (e.g., example 55a) relates to a previously described example (e.g., example or to any of the examples described herein, further comprising that the processing circuitry is configured to negotiate the request for changing the hardware resources with the first sidecar apparatus using a machine-learning model.

Another example (e.g., example 56) relates to a previously described example (e.g., example or 55a) or to any of the examples described herein, further comprising that the processing circuitry is configured to negotiate the request for changing the hardware resources with the first sidecar apparatus via a distributed ledger, such as via a smart contract being executed on the distributed ledger.

Another example (e.g., example 57) relates to a previously described example (e.g., one of the examples 55 to 56) or to any of the examples described herein, further comprising that processing circuitry is configured to negotiate the request for changing the hardware resources with the first sidecar apparatus based on a cost function.

Another example (e.g., example 58) relates to a previously described example (e.g., one of the examples 51 to 57) or to any of the examples described herein, further comprising that the processing circuitry is configured to provide information on hardware resources being available for allocation to the first software application container based on a difference between hardware resources allocated to the second software application container and hardware resources desired or required by the second software application container, with the request being obtained in response to the information on the available hardware resources to the first software application container.

An example (e.g., example 59) relates to a resource management controller apparatus (20) comprising interface circuitry (22) and processing circuitry (24). The processing circuitry is configured to obtain a request for changing the hardware resources allocated to a software application container (102) from a sidecar apparatus (10). The processing circuitry is configured to provide information on hardware resources allocated to the software application container to the sidecar apparatus in response to the request.

Another example (e.g., example 60) relates to a previously described example (e.g., example 59) or to any of the examples described herein, further comprising that the processing circuitry is configured to determine hardware resources being available for allocation to the software application container, and to provide the information on the hardware resources allocated to the software application container based on the available hardware resources.

Another example (e.g., example 61) relates to a previously described example (e.g., example 60) or to any of the examples described herein, further comprising that the processing circuitry is configured to reduce the hardware resources allocated to a second software application container if the request for changing the hardware resources allocated to the software application container comprises a request for additional hardware resources and if more hardware resources are allocated to the second application container than required or desired by the second software application container.

Another example (e.g., example 62) relates to a previously described example (e.g., one of the examples 60 to 61) or to any of the examples described herein, further comprising that the processing circuitry is configured to increase hardware resources allocated to a second software application container if the request for changing the hardware resources allocated to the software application container comprises one of a command for reducing the hardware resources and a command for reducing the hardware resources after a pre-defined time interval and if fewer hardware resources are allocated to the second application container than desired by the second software application container.

Another example (e.g., example 63) relates to a previously described example (e.g., one of the examples 59 to 62) or to any of the examples described herein, further comprising that the processing circuitry is configured to provide information on hardware resources that are available for allocation to the software application container to the software application container sidecar, with the request being obtained in response to the information on the available hardware resources to the software application container, and to provide the information on the available hardware resources to the software application container based on a difference between hardware resources allocated to one or more second software application containers and hardware resources desired or required by the one or more second software application containers.

Another example (e.g., example 64) relates to a previously described example (e.g., one of the examples 59 to 63) or to any of the examples described herein, further comprising that the processing circuitry is configured to allocate the hardware resources to the first software application container and one or more second software application containers based on at least one of a cost function and telemetry information on a use of hardware resources by software application containers.

An example (e.g., example 65) relates to a sidecar device (10, 10a) comprising means for communicating (12) and means for processing (14). The means for processing (14) is configured to obtain information on hardware resources desired by a software application container (102a) from the software application container. The means for processing (14) is configured to provide a request for changing the hardware resources allocated to the software application container to another entity (10b, 20) capable of influencing an allocation of hardware resources to the software application container.

Another example (e.g., example 66) relates to a previously described example (e.g., example or to any of the examples described herein, further comprising that the other entity is a resource management controller (20) for controlling the allocation of hardware resources to a plurality of software application containers (102).

Another example (e.g., example 67) relates to a previously described example (e.g., one of the examples 65 to 66) or to any of the examples described herein, further comprising that the other entity is a second sidecar device (10b) associated with a second software application container (102b).

Another example (e.g., example 67a) relates to a previously described example (e.g., one of the examples 65 to 67) or to any of the examples described herein, further comprising that the other entity is one of a resource management controller for controlling the allocation of hardware resources to a plurality of software application containers and a second sidecar apparatus associated with a second software application container, with the means for processing being configured to select one of the resource management controller and the second sidecar apparatus based on a pre-defined selection policy.

Another example (e.g., example 68) relates to a previously described example (e.g., one of the examples 65 to 67) or to any of the examples described herein, further comprising that the information on the hardware resources desired by the software application container comprises information on a change in the hardware resources desired by the software application container.

Another example (e.g., example 69) relates to a previously described example (e.g., example 68) or to any of the examples described herein, further comprising that the information on the hardware resources desired by the software application container comprises one of a request for additional hardware resources, a command for reducing the hardware resources, a request for additional hardware resources after a pre-defined time interval, a command for reducing the hardware resources after a pre-defined time interval, a request for exchanging hardware resources, and a request for exchanging hardware resources after a pre-defined time interval.

Another example (e.g., example 70) relates to a previously described example (e.g., example 69) or to any of the examples described herein, further comprising that the request for changing the hardware resources allocated to the software application container comprises one of a request for additional hardware resources, a request for additional hardware resources after a pre-defined time interval, a command for reducing the hardware resources, a command for reducing the hardware resources after a pre-defined time interval, information on hardware resources becoming available for a second software application container, information on hardware resources becoming available for a second software application container after a pre-defined time interval, a request for exchanging hardware resources, and a request for exchanging hardware resources after a pre-defined time interval.

Another example (e.g., example 70a) relates to a previously described example (e.g., one of the examples 65 to 70) or to any of the examples described herein, further comprising that the means for processing is configured to determine a predicted change in the hardware resources desired by the software application container based on the change in the hardware resources desired by the software application container, and to provide the request based on the predicted change.

Another example (e.g., example 71) relates to a previously described example (e.g., one of the examples 65 to 70a) or to any of the examples described herein, further comprising that the means for processing is configured to obtain information on hardware resources that are available for allocation to the software application container, with the request for changing the hardware resources being provided based on the information on the available hardware resources.

Another example (e.g., example 72) relates to a previously described example (e.g., example 71) or to any of the examples described herein, further comprising that the information on the available hardware resources is obtained via a publish-subscribe scheme.

Another example (e.g., example 73) relates to a previously described example (e.g., one of the examples 71 to 72) or to any of the examples described herein, further comprising that the means for processing is configured to request the information on the available hardware resources from the other entity.

Another example (e.g., example 74) relates to a previously described example (e.g., one of the examples 71 to 73) or to any of the examples described herein, further comprising that the means for processing is configured to provide information on the hardware resources allocated to the software application container to the software application container.

Another example (e.g., example 75) relates to a previously described example (e.g., one of the examples 65 to 74) or to any of the examples described herein, further comprising that the means for processing is configured to negotiate the request for changing the hardware resources with the other entity, the other entity being a second sidecar device.

Another example (e.g., example 75a) relates to a previously described example (e.g., example or to any of the examples described herein, further comprising that the means for processing is configured to negotiate the request for changing the hardware resources with the other entity using a machine-learning model.

Another example (e.g., example 76) relates to a previously described example (e.g., example or 75a) or to any of the examples described herein, further comprising that the means for processing is configured to negotiate the request for changing the hardware resources with the second sidecar device via a distributed ledger, such as via a smart contract being executed on the distributed ledger.

Another example (e.g., example 77) relates to a previously described example (e.g., one of the examples 75 to 76) or to any of the examples described herein, further comprising that the means for processing is configured to negotiate the request for changing the hardware resources with the other entity based on a cost function.

Another example (e.g., example 78) relates to a previously described example (e.g., one of the examples 65 to 77) or to any of the examples described herein, further comprising that the means for processing is configured to obtain information on hardware resources allocated to the software application container from the other entity in response to the request.

Another example (e.g., example 79) relates to a previously described example (e.g., example 78) or to any of the examples described herein, further comprising that the information on hardware resources allocated to the software application container comprises information on hardware resource being newly allocated to, or withheld from, the software application container.

Another example (e.g., example 80) relates to a previously described example (e.g., one of the examples 65 to 79) or to any of the examples described herein, further comprising that the hardware resources comprise one or more of central processing unit (CPU) resources, graphics processing unit (GPU) resources, memory resources, storage resources, machine-learning accelerator resources, and field-programmable gate array (FPGA) resources.

Another example (e.g., example 81) relates to a previously described example (e.g., one of the examples 65 to 80) or to any of the examples described herein, further comprising that the means for processing is configured to store information on the hardware resources allocated to the software application container over time, and to provide the information on the hardware resources allocated to the software application container in signed or encrypted form.

Another example (e.g., example 82) relates to a previously described example (e.g., example 81) or to any of the examples described herein, further comprising that the means for processing is configured to provide the information on the hardware resources being allocated to the software application container in signed or encrypted form via a distributed ledger.

An example (e.g., example 83) relates to a second sidecar device (10b) comprising means for communicating (12) and means for processing (14). The means for processing (14) is configured to obtain a request for changing the hardware resources allocated to a first software application container (102a) from a first sidecar device (10a), the second sidecar device being associated with a second software application container (102b) being different from the first software application container. The means for processing (14) is configured to provide information on hardware resources allocated to the first software application container to the first sidecar device in response to the request.

Another example (e.g., example 84) relates to a previously described example (e.g., example 83) or to any of the examples described herein, further comprising that the means for processing is configured to adjust the hardware resources used by the second software application container in response to the request for changing the hardware resources allocated to the first software application container, and to provide the information on the hardware resources allocated to the first software application container based on the hardware resources used by the second software application container after the adjustment.

Another example (e.g., example 85) relates to a previously described example (e.g., example 84) or to any of the examples described herein, further comprising that the means for processing is configured to reduce the hardware resources used by the second software application container if the request for changing the hardware resources allocated to the first software application container comprises a request for additional hardware resources and if more hardware resources are allocated to the second application container than required or desired by the second software application container.

Another example (e.g., example 86) relates to a previously described example (e.g., one of the examples 84 to 85) or to any of the examples described herein, further comprising that the means for processing is configured to increase the hardware resources used by the second software application container if the request for changing the hardware resources allocated to the first software application container comprises one of information on hardware resources becoming available for the second software application container and information on hardware resources becoming available for the second software application container after a pre-defined time interval and if fewer hardware resources are allocated to the second application container than desired by the second software application container.

Another example (e.g., example 87) relates to a previously described example (e.g., one of the examples 83 to 86) or to any of the examples described herein, further comprising that the means for processing is configured to negotiate the request for changing the hardware resources with the first sidecar device.

Another example (e.g., example 87a) relates to a previously described example (e.g., example 87) or to any of the examples described herein, further comprising that the means for processing is configured to negotiate the request for changing the hardware resources with the first sidecar apparatus using a machine-learning model.

Another example (e.g., example 88) relates to a previously described example (e.g., example 87 or 87a) or to any of the examples described herein, further comprising that the means for processing is configured to negotiate the request for changing the hardware resources with the first sidecar device via a distributed ledger, such as via a smart contract being executed on the distributed ledger.

Another example (e.g., example 89) relates to a previously described example (e.g., one of the examples 87 to 88) or to any of the examples described herein, further comprising that the means for processing is configured to negotiate the request for changing the hardware resources with the first sidecar apparatus based on a cost function.

Another example (e.g., example 90) relates to a previously described example (e.g., one of the examples 83 to 89) or to any of the examples described herein, further comprising that the means for processing is configured to provide information on hardware resources being available for allocation to the first software application container based on a difference between hardware resources allocated to the second software application container and hardware resources desired or required by the second software application container, with the request being obtained in response to the information on the available hardware resources to the first software application container.

An example (e.g., example 91) relates to a resource management controller device (20) comprising means for communicating (22) and means for processing (24). The means for processing (24) is configured to obtain a request for changing the hardware resources allocated to a software application container (102) from a sidecar device (10). The means for processing (24) is configured to provide information on hardware resources allocated to the software application container to the sidecar device in response to the request.

Another example (e.g., example 92) relates to a previously described example (e.g., example 91) or to any of the examples described herein, further comprising that the means for processing is configured to determine hardware resources being available for allocation to the software application container, and to provide the information on the hardware resources allocated to the software application container based on the available hardware resources.

Another example (e.g., example 93) relates to a previously described example (e.g., example 92) or to any of the examples described herein, further comprising that the means for processing is configured to reduce the hardware resources allocated to a second software application container if the request for changing the hardware resources allocated to the software application container comprises a request for additional hardware resources and if more hardware resources are allocated to the second application container than required or desired by the second software application container.

Another example (e.g., example 94) relates to a previously described example (e.g., one of the examples 92 to 93) or to any of the examples described herein, further comprising that the means for processing is configured to increase hardware resources allocated to a second software application container if the request for changing the hardware resources allocated to the software application container comprises one of a command for reducing the hardware resources and a command for reducing the hardware resources after a pre-defined time interval and if fewer hardware resources are allocated to the second application container than desired by the second software application container.

Another example (e.g., example 95) relates to a previously described example (e.g., one of the examples 91 to 94) or to any of the examples described herein, further comprising that the means for processing is configured to provide information on hardware resources that are available for allocation to the software application container to the software application container sidecar, with the request being obtained in response to the information on the available hardware resources to the software application container, and to provide the information on the available hardware resources to the software application container based on a difference between hardware resources allocated to one or more second software application containers and hardware resources desired or required by the one or more second software application containers.

Another example (e.g., example 96) relates to a previously described example (e.g., one of the examples 91 to 95) or to any of the examples described herein, further comprising that the means for processing is configured to allocate the hardware resources to the first software application container and one or more second software application containers based on at least one of a cost function and telemetry information on a use of hardware resources by software application containers.

An example (e.g., example 97) relates to a method for a software application container sidecar, the method comprising obtaining (110) information on hardware resources desired by a software application container from the software application container. The method comprises providing (130) a request for changing the hardware resources allocated to the software application container to another entity capable of influencing an allocation of hardware resources to the software application container.

Another example (e.g., example 98) relates to a previously described example (e.g., example 97) or to any of the examples described herein, further comprising that the other entity is a resource management controller for controlling the allocation of hardware resources to a plurality of software application containers.

Another example (e.g., example 99) relates to a previously described example (e.g., one of the examples 97 to 98) or to any of the examples described herein, further comprising that the other entity is a second software application container sidecar associated with a second software application container.

Another example (e.g., example 99a) relates to a previously described example (e.g., one of the examples 97 to 99) or to any of the examples described herein, further comprising that the other entity is one of a resource management controller for controlling the allocation of hardware resources to a plurality of software application containers and a second sidecar apparatus associated with a second software application container, with the method comprising selecting one of the resource management controller and the second sidecar apparatus based on a pre-defined selection policy.

Another example (e.g., example 100) relates to a previously described example (e.g., one of the examples 97 to 99a) or to any of the examples described herein, further comprising that the information on the hardware resources desired by the software application container comprises information on a change in the hardware resources desired by the software application container.

Another example (e.g., example 101) relates to a previously described example (e.g., example 100) or to any of the examples described herein, further comprising that the information on the hardware resources desired by the software application container comprises one of a request for additional hardware resources, a command for reducing the hardware resources, a request for additional hardware resources after a pre-defined time interval, a command for reducing the hardware resources after a pre-defined time interval, a request for exchanging hardware resources, and a request for exchanging hardware resources after a pre-defined time interval.

Another example (e.g., example 102) relates to a previously described example (e.g., example 101) or to any of the examples described herein, further comprising that the request for changing the hardware resources allocated to the software application container comprises one of a request for additional hardware resources, a request for additional hardware resources after a pre-defined time interval, a command for reducing the hardware resources, a command for reducing the hardware resources after a pre-defined time interval, information on hardware resources becoming available for a second software application container, information on hardware resources becoming available for a second software application container after a pre-defined time interval, a request for exchanging hardware resources, and a request for exchanging hardware resources after a pre-defined time interval.

Another example (e.g., example 102a) relates to a previously described example (e.g., one of the examples 97 to 102) or to any of the examples described herein, further comprising that the method comprises determining a predicted change in the hardware resources desired by the software application container based on the change in the hardware resources desired by the software application container, and to provide the request based on the predicted change.

Another example (e.g., example 103) relates to a previously described example (e.g., one of the examples 97 to 102a) or to any of the examples described herein, further comprising that the method comprises obtaining (125) information on hardware resources that are available for allocation to the software application container, with the request for changing the hardware resources being provided based on the information on the available hardware resources.

Another example (e.g., example 104) relates to a previously described example (e.g., example 103) or to any of the examples described herein, further comprising that the information on the available hardware resources is obtained via a publish-subscribe scheme.

Another example (e.g., example 105) relates to a previously described example (e.g., one of the examples 103 to 104) or to any of the examples described herein, further comprising that the method comprises requesting (120) the information on the available hardware resources from the other entity.

Another example (e.g., example 106) relates to a previously described example (e.g., one of the examples 103 to 105) or to any of the examples described herein, further comprising that the method comprises providing (150) information on the hardware resources allocated to the software application container to the software application container.

Another example (e.g., example 107) relates to a previously described example (e.g., one of the examples 97 to 106) or to any of the examples described herein, further comprising that the method comprises negotiating (135) the request for changing the hardware resources with the other entity, the other entity being a second software application container sidecar.

Another example (e.g., example 107a) relates to a previously described example (e.g., example 107) or to any of the examples described herein, further comprising that the method comprises negotiating the request for changing the hardware resources with the other entity using a machine-learning model.

Another example (e.g., example 108) relates to a previously described example (e.g., example 107 or 107a) or to any of the examples described herein, further comprising that the method comprises negotiating the request for changing the hardware resources with the second software application container sidecar via a distributed ledger, such as via a smart contract being executed on the distributed ledger.

Another example (e.g., example 109) relates to a previously described example (e.g., one of the examples 107 to 108) or to any of the examples described herein, further comprising that the method comprises negotiating the request for changing the hardware resources with the other entity based on a cost function.

Another example (e.g., example 110) relates to a previously described example (e.g., one of the examples 97 to 109) or to any of the examples described herein, further comprising that the method comprises obtaining (140) information on hardware resources allocated to the software application container from the other entity in response to the request.

Another example (e.g., example 111) relates to a previously described example (e.g., example 110) or to any of the examples described herein, further comprising that the information on hardware resources allocated to the software application container comprises information on hardware resource being newly allocated to, or withheld from, the software application container.

Another example (e.g., example 112) relates to a previously described example (e.g., one of the examples 97 to 111) or to any of the examples described herein, further comprising that the hardware resources comprise one or more of central processing unit (CPU) resources, graphics processing unit (GPU) resources, memory resources, storage resources, machine-learning accelerator resources, and field-programmable gate array (FPGA) resources.

Another example (e.g., example 113) relates to a previously described example (e.g., one of the examples 97 to 112) or to any of the examples described herein, further comprising that the method comprises storing (160) information on the hardware resources allocated to the software application container over time and providing (165) the information on the hardware resources allocated to the software application container in signed or encrypted form.

Another example (e.g., example 114) relates to a previously described example (e.g., example 113) or to any of the examples described herein, further comprising that the method comprises providing the information on the hardware resources being allocated to the software application container in signed or encrypted form via a distributed ledger.

An example (e.g., example 115) relates to a second method for a second software application container sidecar, the second method comprising obtaining (180) a request for changing the hardware resources allocated to a first software application container from a first software application container sidecar, the second software application container sidecar being associated with a second software application container being different from the first software application container. The second method comprises providing (190) information on hardware resources allocated to the first software application container to the first software application container sidecar in response to the request.

Another example (e.g., example 116) relates to a previously described example (e.g., example 115) or to any of the examples described herein, further comprising that the method comprises adjusting (184) the hardware resources used by the second software application container in response to the request for changing the hardware resources allocated to the first software application container and providing the information on the hardware resources allocated to the first software application container based on the hardware resources used by the second software application container after the adjustment.

Another example (e.g., example 117) relates to a previously described example (e.g., example 116) or to any of the examples described herein, further comprising that the method comprises reducing (186) the hardware resources used by the second software application container if the request for changing the hardware resources allocated to the first software application container comprises a request for additional hardware resources and if more hardware resources are allocated to the second application container than required or desired by the second software application container.

Another example (e.g., example 118) relates to a previously described example (e.g., one of the examples 116 to 117) or to any of the examples described herein, further comprising that the method comprises increasing (188) the hardware resources used by the second software application container if the request for changing the hardware resources allocated to the first software application container comprises one of information on hardware resources becoming available for the second software application container and information on hardware resources becoming available for the second software application container after a pre-defined time interval and if fewer hardware resources are allocated to the second application container than desired by the second software application container.

Another example (e.g., example 119) relates to a previously described example (e.g., one of the examples 115 to 118) or to any of the examples described herein, further comprising that the method comprises negotiating (182) the request for changing the hardware resources with the first software application container sidecar.

Another example (e.g., example 119a) relates to a previously described example (e.g., example 119) or to any of the examples described herein, further comprising that the method comprises negotiating the request for changing the hardware resources with the first sidecar apparatus using a machine-learning model.

Another example (e.g., example 120) relates to a previously described example (e.g., example 119 or example 119a) or to any of the examples described herein, further comprising that the method comprises negotiating the request for changing the hardware resources with the first software application container sidecar via a distributed ledger, such as via a smart contract being executed on the distributed ledger.

Another example (e.g., example 121) relates to a previously described example (e.g., one of the examples 119 to 120) or to any of the examples described herein, further comprising that the method comprises negotiating the request for changing the hardware resources with the first sidecar apparatus based on a cost function.

Another example (e.g., example 122) relates to a previously described example (e.g., one of the examples 115 to 121) or to any of the examples described herein, further comprising that the method comprises providing (170) information on hardware resources being available for allocation to the first software application container based on a difference between hardware resources allocated to the second software application container and hardware resources desired or required by the second software application container, with the request being obtained in response to the information on the available hardware resources to the first software application container.

An example (e.g., example 123) relates to a resource management controller method comprising obtaining (220) a request for changing the hardware resources allocated to a software application container from a software application container sidecar. The resource management controller method comprises providing (230) information on hardware resources allocated to the software application container to the software application container sidecar in response to the request.

Another example (e.g., example 124) relates to a previously described example (e.g., example 123) or to any of the examples described herein, further comprising that the method comprises determining (210) hardware resources being available for allocation to the software application container and providing the information on the hardware resources allocated to the software application container based on the available hardware resources.

Another example (e.g., example 125) relates to a previously described example (e.g., example 124) or to any of the examples described herein, further comprising that the method comprises reducing (224) the hardware resources allocated to a second software application container if the request for changing the hardware resources allocated to the software application container comprises a request for additional hardware resources and if more hardware resources are allocated to the second application container than required or desired by the second software application container.

Another example (e.g., example 126) relates to a previously described example (e.g., one of the examples 124 to 125) or to any of the examples described herein, further comprising that the method comprises increasing (226) hardware resources allocated to a second software application container if the request for changing the hardware resources allocated to the software application container comprises one of a command for reducing the hardware resources and a command for reducing the hardware resources after a pre-defined time interval and if fewer hardware resources are allocated to the second application container than desired by the second software application container.

Another example (e.g., example 127) relates to a previously described example (e.g., one of the examples 123 to 126) or to any of the examples described herein, further comprising that the method comprises providing (215) information on hardware resources that are available for allocation to the software application container to the software application container sidecar, with the request being obtained in response to the information on the available hardware resources to the software application container, wherein the information on the available hardware resources to the software application container is provided based on a difference between hardware resources allocated to one or more second software application containers and hardware resources desired or required by the one or more second software application containers.

Another example (e.g., example 128) relates to a previously described example (e.g., one of the examples 123 to 127) or to any of the examples described herein, further comprising that the method comprises allocating the hardware resources to the first software application container and one or more second software application containers based on at least one of a cost function and telemetry information on a use of hardware resources by software application containers.

An example (e.g., example 129) relates to a computer system comprising at least one of the sidecar apparatus according to one of the examples 1 to 18, the second sidecar apparatus according to one of the examples 19 to 26 and the resource management controller apparatus according to one of the examples 27 to 32.

An example (e.g., example 130) relates to a computer system comprising at least one of the sidecar apparatus according to one of the examples 33 to 50, the second sidecar apparatus according to one of the examples 51 to 58 and the resource management controller apparatus according to one of the examples 59 to 64.

An example (e.g., example 131) relates to a computer system comprising at least one of the sidecar apparatus according to one of the examples 65 to 82, the second sidecar apparatus according to one of the examples 83 to 90 and the resource management controller apparatus according to one of the examples 91 to 96.

An example (e.g., example 132) relates to a computer system being configured to perform at least one of the method according to one of the examples 97 to 114, the second method according to one of the examples 115 to 122 and the resource management controller method according to one of the examples 123 to 128.

An example (e.g., example 133) relates to a non-transitory machine-readable storage medium including program code, when executed, to cause a machine to perform at least one the method one of the examples 97 to 114, the method of one of the examples 115 to 122 and the method of one of the examples 123 to 128.

An example (e.g., example 134) relates to a computer program having a program code for performing at least one the method one of the examples 97 to 114, the method of one of the examples 115 to 122 and the method of one of the examples 123 to 128, when the computer program is executed on a computer, a processor, or a programmable hardware component.

An example (e.g., example 135) relates to a machine-readable storage including machine readable instructions, when executed, to implement a method or realize an apparatus as claimed in any pending claim or shown in any example.

The aspects and features described in relation to a particular one of the previous examples may also be combined with one or more of the further examples to replace an identical or similar feature of that further example or to additionally introduce the features into the further example.

Machine learning refers to algorithms and statistical models that computer systems may use to perform a specific task without using explicit instructions, instead relying on models and inference. For example, in machine-learning, instead of a rule-based transformation of data, a transformation of data may be used, that is inferred from an analysis of historical and/or training data. For example, the content of images may be analyzed using a machine-learning model or using a machine-learning algorithm. In order for the machine-learning model to analyze the content of an image, the machine-learning model may be trained using training images as input and training content information as output. By training the machine-learning model with a large number of training images and associated training content information, the machine-learning model “learns” to recognize the content of the images, so the content of images that are not included of the training images can be recognized using the machine-learning model. The same principle may be used for other kinds of sensor data as well: By training a machine-learning model using training sensor data and a desired output, the machine-learning model “learns” a transformation between the sensor data and the output, which can be used to provide an output based on non-training sensor data provided to the machine-learning model.

Machine-learning models are trained using training input data. The examples specified above use a training method called “supervised learning”. In supervised learning, the machine-learning model is trained using a plurality of training samples, wherein each sample may comprise a plurality of input data values, and a plurality of desired output values, i.e., each training sample is associated with a desired output value. By specifying both training samples and desired output values, the machine-learning model “learns” which output value to provide based on an input sample that is similar to the samples provided during the training. Apart from supervised learning, semi-supervised learning may be used. In semi-supervised learning, some of the training samples lack a corresponding desired output value. Supervised learning may be based on a supervised learning algorithm, e.g., a classification algorithm, a regression algorithm or a similarity learning algorithm. Classification algorithms may be used when the outputs are restricted to a limited set of values, i.e., the input is classified to one of the limited set of values. Regression algorithms may be used when the outputs may have any numerical value (within a range). Similarity learning algorithms are similar to both classification and regression algorithms, but are based on learning from examples using a similarity function that measures how similar or related two objects are.

Reinforcement learning forms another group of machine-learning algorithms. In other words, reinforcement learning may be used to train the machine-learning model. In reinforcement learning, one or more software actors (called “software agents”) are trained to take actions in an environment. Based on the taken actions, a reward is calculated. Reinforcement learning is based on training the one or more software agents to choose the actions such, that the cumulative reward is increased, leading to software agents that become better at the task they are given (as evidenced by increasing rewards).

Machine-learning algorithms are usually based on a machine-learning model. In other words, the term “machine-learning algorithm” may denote a set of instructions that may be used to create, train or use a machine-learning model. The term “machine-learning model” may denote a data structure and/or set of rules that represents the learned knowledge, e.g., based on the training performed by the machine-learning algorithm. In embodiments, the usage of a machine-learning algorithm may imply the usage of an underlying machine-learning model (or of a plurality of underlying machine-learning models). The usage of a machine-learning model may imply that the machine-learning model and/or the data structure/set of rules that is the machine-learning model is trained by a machine-learning algorithm.

For example, the machine-learning model may be an artificial neural network (ANN). ANNs are systems that are inspired by biological neural networks, such as can be found in a brain. ANNs comprise a plurality of interconnected nodes and a plurality of connections, so-called edges, between the nodes. There are usually three types of nodes, input nodes that receiving input values, hidden nodes that are (only) connected to other nodes, and output nodes that provide output values. Each node may represent an artificial neuron. Each edge may transmit information, from one node to another. The output of a node may be defined as a (non-linear) function of the sum of its inputs. The inputs of a node may be used in the function based on a “weight” of the edge or of the node that provides the input. The weight of nodes and/or of edges may be adjusted in the learning process. In other words, the training of an artificial neural network may comprise adjusting the weights of the nodes and/or edges of the artificial neural network, i.e., to achieve a desired output for a given input. In at least some embodiments, the machine-learning model may be deep neural network, e.g., a neural network comprising one or more layers of hidden nodes (i.e., hidden layers), preferably a plurality of layers of hidden nodes.

Examples may further be or relate to a (computer) program including a program code to execute one or more of the above methods when the program is executed on a computer, processor, or other programmable hardware component. Thus, steps, operations, or processes of different ones of the methods described above may also be executed by programmed computers, processors, or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations, or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process, or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

As used herein, the term “module” refers to logic that may be implemented in a hardware component or device, software or firmware running on a processing unit, or a combination thereof, to perform one or more operations consistent with the present disclosure. Software and firmware may be embodied as instructions and/or data stored on non-transitory computer-readable storage media. As used herein, the term “circuitry” can comprise, singly or in any combination, non-programmable (hardwired) circuitry, programmable circuitry such as processing units, state machine circuitry, and/or firmware that stores instructions executable by programmable circuitry. Modules described herein may, collectively or individually, be embodied as circuitry that forms a part of a computing system. Thus, any of the modules can be implemented as circuitry. A computing system referred to as being programmed to perform a method can be programmed to perform the method via software, hardware, firmware, or combinations thereof.

Any of the disclosed methods (or a portion thereof) can be implemented as computer-executable instructions or a computer program product. Such instructions can cause a computing system or one or more processing units capable of executing computer-executable instructions to perform any of the disclosed methods. As used herein, the term “computer” refers to any computing system or device described or mentioned herein. Thus, the term “computer-executable instruction” refers to instructions that can be executed by any computing system or device described or mentioned herein.

The computer-executable instructions can be part of, for example, an operating system of the computing system, an application stored locally to the computing system, or a remote application accessible to the computing system (e.g., via a web browser). Any of the methods described herein can be performed by computer-executable instructions performed by a single computing system or by one or more networked computing systems operating in a network environment. Computer-executable instructions and updates to the computer-executable instructions can be downloaded to a computing system from a remote server.

Further, it is to be understood that implementation of the disclosed technologies is not limited to any specific computer language or program. For instance, the disclosed technologies can be implemented by software written in C++, C #, Java, Perl, Python, JavaScript, Adobe Flash, C #, assembly language, or any other programming language. Likewise, the disclosed technologies are not limited to any particular computer system or type of hardware.

Furthermore, any of the software-based examples (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, cable (including fiber optic cable), magnetic communications, electromagnetic communications (including RF, microwave, ultrasonic, and infrared communications), electronic communications, or other such communication means.

The disclosed methods, apparatuses, and systems are not to be construed as limiting in any way. Instead, the present disclosure is directed toward all novel and nonobvious features and aspects of the various disclosed examples, alone and in various combinations and subcombinations with one another. The disclosed methods, apparatuses, and systems are not limited to any specific aspect or feature or combination thereof, nor do the disclosed examples require that any one or more specific advantages be present or problems be solved.

Theories of operation, scientific principles, or other theoretical descriptions presented herein in reference to the apparatuses or methods of this disclosure have been provided for the purposes of better understanding and are not intended to be limiting in scope. The apparatuses and methods in the appended claims are not limited to those apparatuses and methods that function in the manner described by such theories of operation.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A sidecar apparatus comprising interface circuitry, machine-readable instructions and processing circuitry to execute the machine-readable instructions to:
obtain information on hardware resources desired by a software application container from the software application container; and
provide a request for changing the hardware resources allocated to the software application container to another entity capable of influencing an allocation of hardware resources to the software application container.

2. The sidecar apparatus according to claim 1, wherein the other entity is a resource management controller for controlling the allocation of hardware resources to a plurality of software application containers.

3. The sidecar apparatus according to claim 1, wherein the other entity is a second sidecar apparatus associated with a second software application container.

4. The sidecar apparatus according to claim 1, wherein the information on the hardware resources desired by the software application container comprises information on a change in the hardware resources desired by the software application container.

5. The sidecar apparatus according to claim 4, wherein the information on the hardware resources desired by the software application container comprises one of a request for additional hardware resources, a command for reducing the hardware resources, a request for additional hardware resources after a pre-defined time interval, a command for reducing the hardware resources after a pre-defined time interval, a request for exchanging hardware resources, and a request for exchanging hardware resources after a pre-defined time interval.

6. The sidecar apparatus according to claim 5, wherein the request for changing the hardware resources allocated to the software application container comprises one of a request for additional hardware resources, a request for additional hardware resources after a pre-defined time interval, a command for reducing the hardware resources, a command for reducing the hardware resources after a pre-defined time interval, information on hardware resources becoming available for a second software application container, information on hardware resources becoming available for a second software application container after a pre-defined time interval, a request for exchanging hardware resources, and a request for exchanging hardware resources after a pre-defined time interval.

7. The sidecar apparatus according to claim 1, wherein the machine-readable instructions comprise instructions to determine a predicted change in the hardware resources desired by the software application container based on the change in the hardware resources desired by the software application container, and to provide the request based on the predicted change.

8. The sidecar apparatus according to claim 1, wherein the machine-readable instructions comprise instructions to obtain information on hardware resources that are available for allocation to the software application container, with the request for changing the hardware resources being provided based on the information on the available hardware resources.

9. The sidecar apparatus according to claim 8, wherein the machine-readable instructions comprise instructions to request the information on the available hardware resources from the other entity.

10. The sidecar apparatus according to claim 1, wherein the machine-readable instructions comprise instructions to provide information on the hardware resources allocated to the software application container to the software application container.

11. The sidecar apparatus according to claim 1, wherein the machine-readable instructions comprise instructions to negotiate the request for changing the hardware resources with the other entity, the other entity being a second sidecar apparatus.

12. The sidecar apparatus according to claim 1, wherein the machine-readable instructions comprise instructions to obtain information on hardware resources allocated to the software application container from the other entity in response to the request, the information on hardware resources allocated to the software application container comprising information on hardware resource being newly allocated to, or withheld from, the software application container.

13. The sidecar apparatus according to claim 1, wherein the hardware resources comprise one or more of central processing unit (CPU) resources, graphics processing unit (GPU) resources, memory resources, storage resources, machine-learning accelerator resources, and field-programmable gate array (FPGA) resources.

14. The sidecar apparatus according to claim 1, wherein the machine-readable instructions comprise instructions to store information on the hardware resources allocated to the software application container over time, and instructions to provide the information on the hardware resources allocated to the software application container in signed or encrypted form.

15. The sidecar apparatus according to claim 14, wherein the machine-readable instructions comprise instructions to provide the information on the hardware resources being allocated to the software application container in signed or encrypted form via a distributed ledger.

16. A second sidecar apparatus comprising interface circuitry, machine-readable instructions and processing circuitry to execute the machine-readable instructions to:
obtain a request for changing the hardware resources allocated to a first software application container from a first sidecar apparatus, the second sidecar apparatus being associated with a second software application container being different from the first software application container; and
provide information on hardware resources allocated to the first software application container to the first sidecar apparatus in response to the request.

17. The second sidecar apparatus according to claim 16, wherein the machine-readable instructions comprise instructions to adjust the hardware resources used by the second software application container in response to the request for changing the hardware resources allocated to the first software application container, and to provide the information on the hardware resources allocated to the first software application container based on the hardware resources used by the second software application container after the adjustment.

18. The second sidecar apparatus according to claim 16, wherein the machine-readable instructions comprise instructions to negotiate the request for changing the hardware resources with the first sidecar apparatus.

19. The second sidecar apparatus according to claim 16, wherein the machine-readable instructions comprise instructions to provide information on hardware resources being available for allocation to the first software application container based on a difference between hardware resources allocated to the second software application container and hardware resources desired or required by the second software application container, with the request being obtained in response to the information on the available hardware resources to the first software application container.

20. A resource management controller apparatus comprising interface circuitry, machine-readable instructions and processing circuitry to execute the machine-readable instructions to:
obtain a request for changing the hardware resources allocated to a software application container from a sidecar apparatus; and
provide information on hardware resources allocated to the software application container to the sidecar apparatus in response to the request.

21. The resource management controller apparatus according to claim 20, wherein the machine-readable instructions comprise instructions to determine hardware resources being available for allocation to the software application container, and instructions to provide the information on the hardware resources allocated to the software application container based on the available hardware resources.

22. The resource management controller apparatus according to claim 20, wherein the machine-readable instructions comprise instructions to provide information on hardware resources that are available for allocation to the software application container to the software application container sidecar, with the request being obtained in response to the information on the available hardware resources to the software application container, and instructions to provide the information on the available hardware resources to the software application container based on a difference between hardware resources allocated to one or more second software application containers and hardware resources desired or required by the one or more second software application containers.

23. The resource management controller apparatus according to claim 20, wherein the machine-readable instructions comprise instructions to allocate the hardware resources to the first software application container and one or more second software application containers based on at least one of a cost function and telemetry information on a use of hardware resources by software application containers.

24. A method for a software application container sidecar, the method comprising:
obtaining information on hardware resources desired by a software application container from the software application container; and
providing a request for changing the hardware resources allocated to the software application container to another entity capable of influencing an allocation of hardware resources to the software application container.

25. A non-transitory machine-readable storage medium including program code, when executed, to cause a machine to perform the method of claim 24.
